(19) United States
(12) Patent Application Publication
(10) Pub. No.: US 2013/0323390 A1
(43) Pub. Date: Dec. 5, 2013

(54) WATER ACTIVITY REDUCING AGENT, FOOD PRODUCT INCLUDING THE AGENT, AND WATER ACTIVITY REDUCING METHOD

(71) Applicant: UHA Mikakuto Co., Ltd., Yamatokooriyama-shi (JP)

(72) Inventors: Takashi KAWAMURA, Yamatokooriyama-shi (JP); Takeki MATSUI, Yamatokooriyama-shi (JP); Yasumasa YAMADA, Yamatokooriyama-shi (JP); Ichiro YAMADA, Yamatokooriyama-shi (JP)

(21) Appl. No.: 13/905,561

(22) Filed: May 30, 2013

(30) Foreign Application Priority Data
May 31, 2012 (JP) 2012-125011
Sep. 28, 2012 (JP) 2012-216303
Nov. 27, 2012 (JP) 2012-258327

(51) Int. Cl. A23L 3/3481

(52) U.S. Cl. CPC A23L 3/3481
USPC 426/548; 426/658; 426/631; 426/442; 127/30

(57) ABSTRACT

Provided are a water activity reducing agent including two or more carbohydrates selected from the group consisting of sorbitol (A), glucose (B), xylitol (C), erythritol (D), and glycerin (E), a food product including the water activity reducing agent, and a method for reducing the water activity of a food product using the water activity reducing agent.

### BACKGROUND OF THE INVENTION

1. Field of the Invention

The present invention relates to a water activity reducing agent that has a much higher effect of reducing water activity in a food product than that of a conventional water activity reducing agent and that can improve the preservability (shelf life) of a food product, a food product, especially a water-containing chocolate, including the water activity reducing agent, and a method for reducing water activity in a food product using the water activity reducing agent.

2. Description of the Background Art

Improving the preservability of food products is a major theme in the whole food industry handling confectionery having high water content, such as unbaked cakes, processed meat products such as wieners and sausages, rice balls, bread, daily dishes, and other products and thus various methods have been developed to address the theme. Typical indexes closely relating to the food preservability include “water activity.” The water activity value, which is, for example, labeled on some food products in recent years, has been drawing attention from the food industry.

The water activity (hereinafter also called “Aw”) is a numerical value for measuring the amount of free water that microorganisms can use for their growth, and it is known that microorganisms capable of proliferation vary depending on the value. Although the values vary to some degree depending on references, for example, bacterium well known to cause food poisoning, such as salmonella, botulinum, and E. coli are grown in a condition with an Aw of about 0.90 or more and Staphylococcus aureus, which is well known to have very strong toxicity, is grown in a condition with an Aw of 0.80 or more. Food products having a short expiration date have at least an Aw of 0.80 or more and most of such food products have an Aw of 0.90 or more. On this account, in order to increase the food safety and to reduce waste risk of food products, reducing the water activity is very important. It is believed that microorganisms cannot proliferate in a condition with an Aw of less than 0.60.

It is also known that the water activity depends on the molecular weight of a solute dissolved in water and a substance having a smaller molecular weight has a larger effect of reducing the water activity. Typical examples of such a solute include sugar alcohols, which are included in many food products for the purpose of reducing the water activity. Examples of such a food product include a decorated cake including a sugar alcohol such as sorbitol, xylitol, and erythritol (Patent Document 1), a chewing gum including a sugar alcohol (Patent Document 2), a jelly-like composition including a monosaccharide such as glucose and a sugar alcohol such as sorbitol and xylitol (Patent Document 3), and a water-in-oil water-containing chocolate (Patent Document 4).

In addition to the food products, there are a large number of food product examples using a sugar alcohol such as sorbitol, xylitol, and erythritol to reduce the water activity as with Patent Documents 1 to 4. This is supposed to be because common technical knowledge that the sugar alcohols have a larger effect of reducing the water activity than that of sucrose has been widely spread in the food industry as described in Non-Patent Documents 1 and 2.

There is another study of the effect on the water activity in a condition mainly including glycerin (glycerol) in combination with other sugar alcohols (Non-Patent Document 3). Unfortunately, the study was carried out in a region with a high water content (about 95 to 30% by weight) and no examination was carried out in a region with a water content of about 15 to 25% by weight in which the reduction in the water activity is significant for food products. Moreover, as described in Non-Patent Document 2, glycerin is known to have a very high effect of reducing water activity by itself but has a problem of unfavorable flavor for the use in food products.

Techniques for improving the preservability of food products by using a component except sugar alcohols or the component in combination with sugar alcohols typically include a foamable oil-in-water emulsion that includes a carbohydrate as a sugar and/or a sugar alcohol and in which trehalose is included in an amount of 1% by weight or more based on the total amount of the carbohydrates (Patent Document 5), a preservability improving agent including at least one organic acid and a sugar alcohol (Patent Document 6), a preservability improving agent including a sugar alcohol and lysozyme (Patent Document 7), and a food product including a water content controlling agent containing L-arabinose (see Patent Document 8).

Patent Documents 5 and 6 disclose techniques for masking the sweetness due to a sugar alcohol or the sour taste due to an organic acid by the addition of other components, and Patent Document 7 discloses a technique for synergistically suppressing the proliferation of microorganisms by the combination use of a sugar alcohol having a water activity reduction effect and lysozyme having antimicrobial properties. Each Patent Document relates to no technique for synergistically reducing the water activity. Patent Document 8 employs L-arabinose alone not belonging to sugar alcohols that are used based on a common technical knowledge and having a small molecular weight to simply reduce the water activity.

Chocolate containing water has a texture of excellent meltability in the mouth and is used for high quality chocolate such as truffles, ganache, and soft chocolate. However, chocolate having a high water content, such as ganache is excellent in meltability in the mouth but has a high water activity of 0.80 or more and thus has a disadvantage of low preservability. On this account, such a food product cannot be stored and distributed at ambient temperature and humidity at present. To address this problem, many techniques have been developed in order to reduce the water activity in chocolate having a high water content thereby to enable the distribution at ambient temperature and humidity.

One of the developed techniques for reducing the water activity of a water-containing chocolate is a method for producing a water-containing chocolate (Patent Document 9). The method uses an aqueous component, an emulsifier having an HLB value of 7.0 or more, and chocolate dough in an amount of 50% by weight or more based on the total amount and adjusts the water content to 10 to 20% by weight and the oil and fat content to 15 to 25% by weight, thereby enabling long-term distribution of the water-containing chocolate at ambient temperature. However, the water-containing chocolate disclosed in Patent Document 9, which has a water activity value of around 0.75 to 0.70, is unlikely to have sufficient long-term distribution properties.

In addition, an oil-in-water emulsified chocolate is disclosed (Patent Document 10). The chocolate includes an aqueous phase component containing at least one selected from invert sugar, starch syrup, fructose, glucose, sucrose, liquid sugar, and honey and having a sugar content of 60 or more and an oil phase component as chocolate dough. This chocolate obtains high long-term preservability by using particular carbohydrates in the aqueous phase component and further increasing the sugar content to 60 or more. Such chocolate is believed to maintain good meltability in the mouth and good flavor even after the storage at 15° C. for 4 months. However, there is assumed to be a room for improvement in the long-term distribution properties at ambient temperature and humidity.

One of the developed techniques for reducing the water activity of a water-containing chocolate by using a sugar alcohol is a chocolate-containing confectionery that includes a sugar alcohol having a melting point of 100° C. or higher and selected from erythritol, mannitol, maltitol, and lactitol in an amount of 1% by mass or more and less than 10% by mass and that has a water content of 2 to 15% by weight (Patent Document 11). The chocolate-containing confectionery described in Patent Document 11 exclusively includes a confectionery having a water content of about 4% by weight and a water activity of about 0.63 to 0.74. It is unclear whether a soft chocolate-like confectionery having a water activity of less than 0.60 can be obtained in the condition of a water content of 12% by weight or more or not.

The applicants of the present invention have applied for a patent on a soft chocolate-like composition including a sugar alcohol (Patent Document 12). According to Patent Document 12, by containing a monosaccharide and/or a disaccharide except sugar alcohols, such as sucrose and a sugar alcohol in predetermined ratios by weight thereby to achieve an oil-in-water emulsified structure, a soft chocolate-like composition having a comparatively high water content can obtain a very low water activity range of less than 0.60. Examples in Patent Document 12 merely describe the combination use of sorbitol and xylitol in the presence of a monosaccharide and/or a disaccharide in a predetermined amount.

As described above, previously proposed techniques have a room for improvement in the effect of reducing water activity. A technique of mixing a number of particular carbohydrates in particular ratios thereby to greatly reduce the water activity of a food product than ever before and a food product employing the technique thereby to obtain surprisingly improved preservability have failed to be proposed.

### CITATION LIST

### Patent Literatures

Patent Document 1: JP-A No. 09-037717
Patent Document 2: JP No. 2997472
Patent Document 3: JP-A No. 2002-238475
Patent Document 4: JP-A No. 2002-306077
Patent Document 5: JP-A No. 09-275922
Patent Document 6: JP-A No. 2006-121994
Patent Document 7: JP-A No. 2003-204776
Patent Document 8: JP-A No. 2004-215614
Patent Document 9: JP-A No. 2001-275570
Patent Document 10: JP-A No. 2001-149014
Patent Document 11: JP No. 4331013
Patent Document 12: JP-A No. 2011-177087

### Non-Patent Literatures

Non-Patent Document 1: Monthly Food Chemical, 2009, Vol. 25, No. 11, pp 19-21
Non-Patent Document 2: Monthly Food Chemical, 2009, Vol. 25, No. 11, pp 34-38
Non-Patent Document 3: Water Activity in Polyol Systems, Journal of Chemical and Engineering Data, 45, 2000, pp 654-660

### SUMMARY OF THE INVENTION

### Technical Problem

An object of the present invention is to provide a water activity reducing agent having a remarkably high effect of reducing water activity of a food product, various food products that include the water activity reducing agent and have higher preservability than ever before, especially a water-containing chocolate having such characteristics, and a method for reducing water activity of a food product.

### Solution to Problem

As a result of repeated intensive studies in order to solve the problems, the present inventors have surprisingly found that adding two or more particular carbohydrates selected from the group consisting of sorbitol, glucose, xylitol, erythritol, and glycerin in a predetermined weight ratio synergistically and remarkably increases the effect of reducing water activity as compared with the single use of each carbohydrate, and have completed a water activity reducing agent of the present invention. The present inventors have also found that using the water activity reducing agent enables the production of various food products, especially a water-containing chocolate, having higher preservability than ever before without impairing flavor and texture of the food product, and have accomplished the invention.

That is, the present invention relates to a water activity reducing agent including two or more carbohydrates selected from the group consisting of sorbitol (A), glucose (B), xylitol (C), erythritol (D), and glycerin (E), composition of the agent and contents [A] to [E] of the respective carbohydrates satisfying a requirement [1], [2], [3], or [4];

[1] the agent including (A) and/or (B) and (C) and the content [C] being 50 to 75% by weight (hereinafter, an agent satisfying the requirement is regarded as a water activity reducing agent [1]);
[2] the agent including (A) and/or (B) and (D) and the content [D] being 20 to 33.3% by weight (hereinafter, an agent satisfying the requirement is regarded as a water activity reducing agent [2]);
[3] the agent including (A) and/or (B), (C), and (D), the sum of the content [A] and the content [B] being 20 to 80% by weight, and the content [D] being more than 0% by weight and 25% by weight or less (hereinafter, an agent satisfying the requirement is regarded as a water activity reducing agent [3]); and
[4] the agent including two or more carbohydrates selected from (A) to (D) and (E), the sum of the content [A] and the content [B] being 80% by weight or less, the content [C] being 75% by weight or less, the content [D] being 33.3% by weight or less, and the content [E] being more than 0% by weight and 25% by weight or less (hereinafter, an agent satisfying the requirement is regarded as a water activity reducing agent [4]).

The present invention also relates to a food product including the water activity reducing agent.

In an aspect of the food product of the present invention, it is preferable that the food product include the water activity reducing agent and have a water content of more than 25% by weight.

In another aspect of the food product of the present invention, it is preferable that the food product have a water content of 12 to 25% by weight and a water activity of less than 0.60 and include the water activity reducing agent in an amount of 10 to 70% by weight.

In another aspect of the food product of the present invention, it is preferable that the water activity reducing agent include sorbitol (A), xylitol (B), and erythritol (C).

The present invention also relates to a water-containing chocolate including a water phase component and an oil phase component mainly containing chocolate, the water phase component including the water activity reducing agent and having a water content of 12 to 20% by weight and a water activity of less than 0.60.

In the water-containing chocolate of the present invention, it is preferable that the proportion of the total content of the carbohydrates included in the water activity reducing agent with respect to the water content of the water-containing chocolate be 160 to 200% by weight and the water activity be less than 0.60.

The present invention further relates to a method for reducing water activity including adding a water activity reducing agent to a food product to reduce water activity of the food product, the water activity reducing agent being the water activity reducing agent above.

In the method for reducing water activity of the present invention, it is preferable that the water activity reducing agent be added in aqueous solution form to the food product.

### Effects of Invention

The present invention can provide a water activity reducing agent that has a much higher effect of reducing water activity than those of sugar alcohols conventionally used based on common technical knowledge, in order to reduce the water activity of a food product thereby to increase the preservability of the food product as much as possible and that can impart good flavor to a food product even including glycerin. Using the water activity reducing agent enables the production of a food product, especially a water-containing chocolate, having excellent preservability and good flavor and texture.

### BRIEF DESCRIPTION OF DRAWINGS

FIG. 1 is a graph showing the relation between a solid content (% by weight) and a water activity in each aqueous solution of sorbitol, xylitol, and glycerin.

FIG. 2 is a graph showing the relation between a solid content (% by weight) and a water activity in each aqueous solution of sorbitol, glucose, and fructose.

FIG. 3 is a graph showing a water activity of each aqueous solution of water activity reducing agents of Examples 1 to 3 and Comparative Examples 1 to 3, sorbitol (S), and xylitol (X) at a solid content of 75% by weight.

FIG. 4 is a graph showing a water activity of each aqueous solution of water activity reducing agents of Examples 4 and 5 and Comparative Example 5 and sorbitol (S) at a solid content of 75% by weight.

FIG. 5 is a graph showing a water activity of each aqueous solution of water activity reducing agents of Examples 6 to 11 and Comparative Example 6, sorbitol (S), and xylitol (X) at a solid content of 75% by weight.

FIG. 6 is a graph showing a water activity of each aqueous solution of water activity reducing agents of Examples 14 to 18 and Comparative Examples 14 to 17, sorbitol (S), glucose (Gu), and xylitol (X) at a solid content of 75% by weight.

FIG. 7 is a graph showing a water activity of each aqueous solution of water activity reducing agents of Examples 19 to 22 and Comparative Examples 19 and 20, sorbitol (S), glucose (Gu), and xylitol (X) at a solid content of 75% by weight.

FIG. 8 is a graph showing a water activity of each aqueous solution of water activity reducing agents of Examples 23 to 32 and Comparative Examples 21 and 25, sorbitol (5), glucose (Gu), and xylitol (X) at a solid content of 75% by weight.

FIG. 9 is a graph showing a water activity of each aqueous solution of water activity reducing agents of Examples 41 to 46 and Comparative Examples 26 to 28, sorbitol (S), glycerin (Gl), and xylitol (X) at a solid content of 75% by weight.

### DESCRIPTION OF EMBODIMENTS

### [Water Activity Reducing Agent]

A water activity reducing agent of the present invention includes two or more carbohydrates selected from the group consisting of sorbitol (A), glucose (B), xylitol (C), erythritol (D), and glycerin (E), and composition of the agent and contents [A] to [E] of the respective carbohydrates satisfy the requirement [1], [2], [3], or [4].

In the present specification, sorbitol (A), glucose (B), xylitol (C), erythritol (D), and glycerin (E) may be abbreviated as (A), (B), (C), (D), and (E), respectively, and may also be abbreviated as sorbitol, glucose, xylitol, erythritol, and glycerin, respectively. In the present specification, the value of water activity is a value determined in a condition at 25° C.

In the present specification, the content of each carbohydrate is as below. First, the total amount of the carbohydrates (A) to (E) included in a water activity reducing agent is regarded as “total amount [X] of carbohydrates in a water activity reducing agent.” The content of sorbitol (A) is a percentage (% by weight) of the amount of sorbitol (A) included in a water activity reducing agent with respect to the total amount [X] of carbohydrates in the water activity reducing agent. As with the content of sorbitol (A), each content of glucose (B), xylitol (C), erythritol (D), and glycerin (E) is a percentage (% by weight) of each amount of (B) to (E) included in a water activity reducing agent with respect to the total amount f carbohydrates in the water activity reducing agent. The contents of sorbitol (A), glucose (B), xylitol (C), erythritol (D), and glycerin (E) may be indicated by [A], [B], [C], [D], and [E], respectively.

Sorbitol, xylitol, erythritol, and glycerin used in the water activity reducing agent belong to sugar alcohols that are formed by reducing a carbonyl group of an aldose or a ketose into a hydroxy group. A sugar alcohol is often used for the purpose of reducing the water activity of a food product. One of the largest factors of reducing the water activity is a small molecular weight. Sucrose that is most frequently used as the carbohydrate has a molecular weight of 342.30, whereas sorbitol has a molecular weight of 182.17, xylitol has a molecular weight of 152.15, erythritol has a molecular weight of 122.12, and glycerin has a molecular weight of 92.09. The molecular weights of these four sugar alcohols are at most about a half of that of sucrose. Glucose is a monosaccharide having a cyclic structure and has a molecular weight of 180.16, whose molecular weight is similar to that of sorbitol.

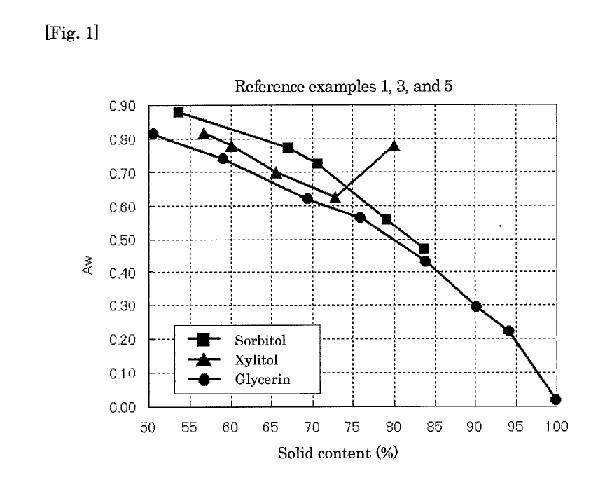

From the consideration of molecular weights alone, it is supposed that glycerin has the highest effect of reducing water activity, followed by erythritol, xylitol, and sorbitol in descending order, among these four sugar alcohols, but this is not completely equal to the actual result (FIG. 1). This is because erythritol and xylitol are likely to crystallize and the generated crystals discharge water to excessively increase water activity. Thus, a sugar alcohol having a smaller molecular weight does not necessarily achieve a smaller water activity in proportion to the molecular weight depending on the solid content of an aqueous solution. Glycerin (glycerol) that is a substance having the smallest molecular weight among the sugar alcohols can greatly reduce water activity as apparent from FIG. 1, and the water activity in an aqueous glycerin solution is less than 0.60 in the condition of a solid content of about 71.5% by weight or more (a water content of about 28.5% by weight or less). Unfortunately, glycerin is unfavorable in the point of flavor, thus substantially limiting the amount added. On this account, it is difficult to sufficiently utilize the water reducing performance.

The study by the present inventors has revealed that using two or more particular carbohydrates selected from these four sugar alcohols and glucose in a particular weight ratio achieves a water activity reduction effect that a single use of each carbohydrate cannot achieve and that is higher than that by using a sugar alcohol known to have an excellent effect of reducing water activity of a food product and has also revealed that the reduction effect is not an additive effect but a synergistic effect. In particular, it is revealed that using sorbitol and/or glucose in combination with xylitol and/or erythritol at a particular weight ratio allows sorbitol and glucose to suppress the crystallization of xylitol and erythritol and this synergistically achieves the respective effects of reducing the water activity. It is also revealed that adding glycerin to the combination of carbohydrates not only greatly reduces the water activity but also can mask flavor of the glycerin.

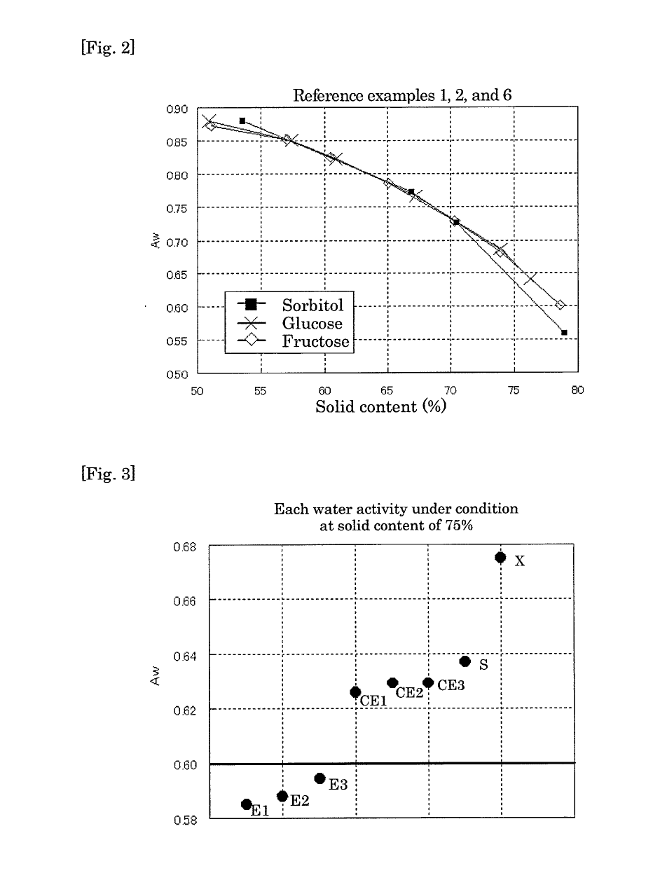

Glucose has a little smaller molecular weight than the molecular weight of sorbitol but the water activity in the presence of glucose alone is higher than that of sorbitol especially in a region having a large solid content (a small water content) in an aqueous solution (FIG. 2). However, the study by the present inventors has revealed that including glucose in combination with xylitol, erythritol, and glycerin at a particular weight ratio can achieve a water activity reduction effect equivalent to that of sorbitol. Fructose that is a monosaccharide having a cyclic structure as with glucose has the same molecular weight as that of glucose but can fail to achieve the synergistic water activity reduction effect.

The water activity reducing agent includes embodiments of water activity reducing agents [1] to [4] in which composition (carbohydrate composition) and contents [A] to [E] of the respective carbohydrates (A) to (E) satisfy predetermined requirements.

A water activity reducing agent [1] includes sorbitol (A) and/or glucose (B) and xylitol (C). The water activity reducing agent [1] includes an embodiment including the carbohydrates (A) to (C), an embodiment including the carbohydrates (A) and (C), and an embodiment including the carbohydrates (B) and (C). In the water activity reducing agent [1], the content [C] of xylitol (C) is 50 to 75% by weight, preferably 50 to 70% by weight, and more preferably 60 to 70% by weight.

A water activity reducing agent [1] having a content [C] in the range allows sorbitol (A) and glucose (B) to work so as to suppress the crystallization of xylitol (C) and then sorbitol (A) and/or glucose (B) and xylitol (C) synergistically work, thus affording a water activity reducing agent having a remarkably increased effect of reducing water activity. A content [C] of less than 50% by weight may fail to sufficiently achieve the synergistic reduction effect of water activity, and a content [C] of more than 75% by weight may readily generate the crystal of xylitol (C).

In the water activity reducing agent [1], the content [A] and the content [B] are not particularly limited, but the total content [A] and [B] of the content [A] and the content [B] is preferably 25 to 50% by weight, more preferably 30 to 50% by weight, and even more preferably 30 to 40% by weight. A water activity reducing agent [1] having a total content [A] and [B] of more than 50% by weight may achieve an insufficient effect of reducing the water activity of a food product. Such an agent may also achieve insufficient masking of flavor. A total content [A] and [B] of less than 25% by weight may readily generate the crystal of xylitol (C).

A water activity reducing agent [1] without sorbitol (A) has a content [A] of 0% by weight. Accordingly, the total content [A] and [B] is a value of the content [B] alone. In a similar manner, an agent without glucose (B) has a content [B] of 0% by weight. Accordingly, the total content [A] and [B] is a value of the content [A] alone. This is also applied to the water activity reducing agents [2] to [4] described later in a similar manner.

The water activity reducing agent [1] preferably has a total content [A] and [B] of 25 to 50% by weight and a content [C] of 50 to 75% by weight, more preferably has a total content [A] and [B] of 30 to 50% by weight and a content [C] of 50 to 70% by weight, and even more preferably has a total content [A] and [B] of 30 to 40% by weight and a content [C] of 60 to 70% by weight.

A water activity reducing agent [2] includes sorbitol (A) and/or glucose (B) and erythritol (D). The water activity reducing agent [2] includes an embodiment including the carbohydrates (A), (B), and (D), an embodiment including the carbohydrates (A) and (D), and an embodiment including the carbohydrates (B) and (D). In the water activity reducing agent [2], the content [D] of erythritol (D) is 20 to 33.3% by weight and preferably 25 to 30% by weight. Here, “33.3% by weight” is a value rounded to one decimal place.

A water activity reducing agent [2] having a content [D] in the range allows sorbitol (A) and glucose (B) to work so as to suppress the crystallization of erythritol (D) and then sorbitol (A) and/or glucose (B) and erythritol (D) synergistically work, thus affording a water activity reducing agent having a remarkably increased effect of reducing water activity. A content [D] of less than 20% by weight may fail to sufficiently achieve the synergistic reduction effect of water activity, and a content [D] of more than 33.3% by weight may readily generate the crystal of erythritol (D).

In the water activity reducing agent [2], the content [A] and the content [B] are not particularly limited, but the total content [A] and [B] is preferably 66.7 to 80% by weight and more preferably 70 to 75% by weight. A water activity reducing agent [2] having a total content [A] and [B] of less than 66.7% by weight may readily generate the crystal of erythritol (D). An agent having a total content [A] and [B] of more than 80% by weight may achieve an insufficient effect of reducing the water activity of a food product. Such an agent may also achieve insufficient masking of flavor.

The water activity reducing agent [2] preferably has a content [D] of 20 to 33.3% by weight and a total content [A] and [B] of 66.7 to 80% by weight and more preferably has a content [D] of 25 to 30% by weight and a total content [A] and [B] of 70 to 75% by weight.

A water activity reducing agent [3] includes sorbitol (A) and/or glucose (B), xylitol (C), and erythritol (D). The water activity reducing agent [3] includes an embodiment including the carbohydrates (A) to (D), an embodiment including the carbohydrates (A), (C), and (D), and an embodiment including the carbohydrates (B) to (D). In the water activity reducing agent [3], the content [A] and the content [B] are not particularly limited but the total content [A] and [B] is 20 to 80% by weight, preferably 20 to 60% by weight, and more preferably 25 to 35% by weight.

A water activity reducing agent [3] having a total content [A] and [B] in the range can suppress the crystallization of xylitol (C) and erythritol (D) and can also suppress the cool feeling of xylitol (C) and erythritol (D). A total content [A] and [B] of less than 20% by weight may readily generate the crystal of either xylitol (C) or erythritol (D). A total content [A] and [B] of more than 80% by weight reduces the water activity reduction effect. In addition, a water activity reducing agent [3] having such a total content and mainly including sorbitol (A) has increased unpleasant sweetness derived from sorbitol (A) and thus may have impaired flavor.

In the water activity reducing agent [3], the content [C] and the content [D] are not particularly limited but the content [D] is preferably more than 0 and 25% by weight or less, more preferably 6 to 25% by weight, and even more preferably 15 to 25% by weight and the content [C] is preferably a balance after the total content [A] and [B] and the content [D] are selected from the ranges. A content [D] of more than 25% by weight may readily generate the crystal of erythritol (D).

The water activity reducing agent [3] preferably has a total content [A] and [B] of 20 to 60% by weight, a content [D] of 6 to 25% by weight or less, and a content [C] of the balance, more preferably has a total content [A] and [B] of 25 to 35% by weight, a content [D] of 15 to 25% by weight, and a content [C] of 40 to 60% by weight, and even more preferably has a total content ratio [A] and [B]:[C]:[D] of 25:50:25. In addition, using these three or four carbohydrates in a preferred ratio not only further increases the effect of reducing water activity and but also further remarkably suppresses the cool feeing and unpleasant sweetness derived from sugar alcohols.

A water activity reducing agent [4] includes two or more carbohydrates selected from (A) to (D) and glycerin (E). In other words, the water activity reducing agent [4] includes at least three carbohydrates containing glycerin (E). The water activity reducing agent [4] includes an embodiment including the water activity reducing agent [1] and glycerin, an embodiment including the water activity reducing agent [2] and glycerin, and an embodiment including the water activity reducing agent [3] and glycerin. Adding glycerin (E) to the water activity reducing agents [1] to [3] enables easy production of a water activity reducing agent [4] having a higher effect of reducing water activity.

In the water activity reducing agent [4], the content [E] of glycerin (E) is more than 0% by weight and 25% by weight or less, preferably 5 to 15% by weight, and more preferably 7.5 to 12.5% by weight. A content [E] of more than 25% by weight is unfavorable because of strong flavor of glycerin (E).

In a water activity reducing agent [4] including sorbitol (A) and/or glucose (B), the total content [A] and [B] is more than 0% by weight and 80% by weight or less and preferably 12.5 to 60% by weight. In a water activity reducing agent [4] including xylitol (C), the content [C] is more than 0% by weight and 75% by weight or less and preferably 15 to 60% by weight. In a water activity reducing agent [4] including erythritol (D), the content [D] is more than 0% by weight and 33.3% by weight or less and preferably 5 to 25% by weight.

A water activity reducing agent [4] in which at least one of the total contents [A] and [B], the content [C], and the content [D] exceeds the range raises problems similar to those of the water activity reducing agents [1] to [3], for example, the synergistic effect of reducing water activity is reduced and xylitol (C) and erythritol (D) crystallize A preferred embodiment for suppressing the crystallization include an embodiment including sorbitol (A), glucose (B), and glycerin (E) in a total content [A], [B], and [E] of 20% by weight or more. Each carbohydrate can be used in an amount selected from the content range described above of each carbohydrate so as to give a total content of each carbohydrate of 100% by weight.

The water activity reducing agent of the present invention may include various additives conventionally known to reduce water activity, common food additives except the water activity reducing additives, and other additives within a range not impairing the water activity reduction effect of the agent, especially the effect of suppressing the crystallization of xylitol (C) and erythritol (D) by sorbitol (A), glucose (B), and glycerin (E).

The water activity reducing agent of the present invention may be prepared into a powder form, a paste form, or a liquid form. For example, the water activity reducing agents [1] to [3] can be prepared as a powdered water activity reducing agent by using two or more powdered carbohydrates selected from the group consisting of sorbitol (A), glucose (B), xylitol (C), and erythritol (D) and mixing them at a predetermined content. The water activity reducing agent [4] can be prepared as a paste-like water activity reducing agent, for example, by mixing a liquid glycerin (E) with two or more powdered carbohydrates selected from the group consisting of sorbitol (A), glucose (B), xylitol (C), and erythritol (D) at a predetermined content.

The powdered or paste-like water activity reducing agent may be dissolved in a solvent usable for a food product thereby to yield a liquid water activity reducing agent. Examples of the solvent include water and a mixed solvent of water and ethanol. The dissolution of the powdered or paste-like water activity reducing agent in a solvent may be carried out under heat as needed. The concentration (solid content) of the water activity reducing agent in a solution of the water activity reducing agent is not particularly limited but is preferably in a range of about 60 to 80% by weight in consideration of easy addition into various food products and preservability. The concentration of the water activity reducing agent in the solution may be adjusted by water addition and/or by heat depending on, for example, the type of a food product to which the water activity reducing agent is added.

Two or more carbohydrates selected from the group consisting of sorbitol (A), glucose (B), xylitol (C), and erythritol (D) or the two or more carbohydrates and glycerin (E) may be independently prepared at a predetermined content into a powdered agent, a paste-like agent, or a liquid agent and these agents may be added to a food product.

The water activity reducing agent of the present invention can be added in any production process of a food product. Provided that a powdered or paste-like water activity reducing agent is used, a process of making the water activity reducing agent a dissolved state in a food product is required. The dissolved state is a state in which the whole carbohydrates included in the water activity reducing agent of the present invention are dissolved in a solvent such as water. Specific examples of the process of making the dissolved state include a process of adding a powdered or paste-like water activity reducing agent to a food product having a high water content and capable of dissolving the whole carbohydrates or an intermediate of the food product and mixing them to dissolve the agent and a process of dissolving a powdered or paste-like water activity reducing agent in a solvent such as water to make a liquid water activity reducing agent, then adding the liquid water activity reducing agent to a food product or an intermediate of the food product, and mixing them. Such a process may be carried out concurrently with another process or may be carried out separately from other processes. This allows the water activity of a food product to be easily adjusted even using a powdered or paste-like water activity reducing agent.

### [Food Product Including Water Activity Reducing Agent and Method for Reducing Water Activity]

A food product of the present invention is characterized by including the water activity reducing agent of the present invention. Adding the water activity reducing agent of the present invention can remarkably reduce the water activity of a food product than ever before and can further improve the preservability of a food product. The amount of the water activity reducing agent in the food product of the present invention is not particularly limited and can be appropriately selected depending on the type and form of a food product, an intended water activity value, and other factors. The food product of the present invention encompasses a food product of a first embodiment and a food product of a second embodiment described below. The contents [A] to [E] of the carbohydrates used in the water activity reducing agent is not a ratio with respect to the whole food product including the water activity reducing agent but is a ratio in the water activity reducing agent.

The food product of the first embodiment includes the water activity reducing agent of the present invention and has a water content of 25% by weight or more. In other words, adding the water activity reducing agent of the present invention to a food product having a water content of 25% by weight or more can yield the food product of the first embodiment. The food product having a water content of 25% by weight or more can be stored only for a very short period of time because it has a high water content and a high water activity. Adding the water activity reducing agent of the present invention to such a food product can moderately reduce the water activity of a food product, and elongate the storage period of the food product without impairing the flavor and texture of the food product.

Examples of the food product having a water content of 25% by weight or more includes wide variety food products meeting the water content range and the water activity range, including food products containing cooked rice, such as rice balls, cooked rice with adzuki beans, and pressed sushi; food products containing wheat flour, such as bread, cakes, raw noodles, and baked sweets; processed meat products such as wieners, sausages, and ham; and various daily dishes containing vegetables, meat, seafood, and other ingredients. In addition to these food products for humans, the water activity reducing agent can also be applied to pet food products. However, the agent should be used after checking whether it is toxic to an intended animal or not, for example, xylitol is toxic to dogs.

The amount of the water activity reducing agent in the food product of the first embodiment of the present invention is not particularly limited and can be appropriately selected from a wide range while considering the type of a food product, an intended elongation degree of storage period, the influence on the flavor and texture of a food product, and other factors. The amount is preferably 0.01 to 20% by weight and more preferably 0.1 to 5% by weight based on the total amount. A water activity reducing agent in an amount of less than 0.01% by weight may achieve an insufficient effect of reducing the water activity of a food product. A water activity reducing agent in an amount of more than 20% by weight may provide excessive sweetness to impair the flavor of a food product.

The food product of the second embodiment of the present invention includes the water activity reducing agent of the present invention in an amount of 10 to 70% by weight based on the total amount and has a water content of 12 to 25% by weight and preferably 12 to 20% by weight and a water activity of less than 0.60. In other words, adding the water activity reducing agent of the present invention in a predetermined amount to a food product having a water content of 12 to 25% by weight can yield the food product of the second embodiment having a water activity of less than 0.60. A water activity reducing agent in an amount of less than 10% by weight may achieve an insufficient effect of reducing water activity. A water activity reducing agent in an amount of more than 70% by weight may provide excessive sweetness to impair the flavor of a food product.

Examples of the food product of the second embodiment of the present invention include, but are not necessarily limited to, food products meeting the water content range and the water activity range, including Western confectionery such as chocolate, jelly, sweet bun, cake, pudding, and jam; Japanese confectionery such as “manju” (a bun with a bean jam), “castella” (a type of sponge cake), “yokan” (a sweet jelly of beans), bean jam, and “dango” (a boiled starch paste); processed meat products such as wieners, sausages, and ham; processed fish meat products such as “kamaboko” (a processed fish cake) and “chikuwa” (a processed fish meat); rice balls; sushi; and daily dishes. Among them, a food product having a high water content preferably includes the water activity reducing agent of the present invention. The water activity reducing agent may be added to such a food product in any production stage and can be added at an appropriate timing in the production process of the food product. Among the food products of the second embodiment, a water-containing chocolate can be examplified as one of the food products for which the water activity reducing agent of the present invention is most useful.

A water-containing chocolate of the present invention can be obtained, for example, by emulsifying a water phase component including the water activity reducing agent of the present invention and an oil phase component mainly including chocolate into an oil-in-water emulsion.

In the water-containing chocolate of the present invention, the water phase component includes the water activity reducing agent of the present invention and has a water content [Y] of 12 to 20% by weight and a water activity of less than 0.60. In the water-containing chocolate of the present invention in a preferred embodiment, the water phase component includes the water activity reducing agent of the present invention and has a water content [Y] of 12 to 20% by weight and a water activity of less than 0.60 and the proportion [Z] of the total content [X] of carbohydrates in the water activity reducing agent with respect to the water content [Y] is 160% to 200%.

The water content [Y] is a water content (% by weight) in the water-containing chocolate and is a value determined by drying under reduced pressure. The proportion [Z] can be determined in accordance with the equation below.

Proportion[Z](% by weight)={([X]/[Y])×100}

The water phase component in the water-containing chocolate of the present invention may include other carbohydrates as the carbohydrate in addition to the carbohydrates (A) to (E) within a range not impairing the advantageous effects of the water activity reducing agent of the present invention. Examples of such a carbohydrate include, but are not necessarily limited to, carbohydrates including monosaccharides except glucose, such as fructose and galactose; disaccharides such as sucrose, lactose, maltose, trehalose, and cellobiose; sugar alcohols except sorbitol, xylitol, erythritol, and glycerin; trisaccharides; tetrasaccharides; oligosaccharides; and polysaccharides; and materials mainly containing carbohydrates, such as fruit juice. Among these carbohydrates, monosaccharides and disaccharides are preferred from the viewpoint of the texture and water activity of a water-containing chocolate. A water activity reducing agent [1] used as the water activity reducing agent preferably includes monosaccharides and/or disaccharides except sucrose and reduced malt sugar starch syrup. Carbohydrates except the carbohydrates (A) to (E) may be used singly or in combination of two or more of them.

The amount of carbohydrates except the carbohydrates (A) to (E) is preferably 10% by weight or less based on the total amount of the water-containing chocolate. The oil phase component in a water-containing chocolate may include carbohydrates such as sucrose. Such a carbohydrate in the oil phase component has little effect on the water activity of the water-containing chocolate of the present invention and thus is not included in the amount of carbohydrates.

The water phase component in the water-containing chocolate of the present invention may further include various liquid food products capable being added to food products and powders for food products capable of being dissolved in the water phase component, such as dairy products, acidulants, vitamins, antimicrobial agents, emulsifiers, salts, coffee powder, tea powder, liquor powder, vegetable powder, fruit powder, coloring agents, foreign liquor, flavors, and the like. The liquid food product and the powder for food products may be added after the water phase component and the oil phase component are mixed. In such a case, the amount of the liquid or powder is preferably in a degree not to affect the water content of the water-containing chocolate. The liquid food product and the powder for food products may include at least one of the carbohydrates (A) to (E). However, the liquid food product and the powder for food products include the carbohydrates (A) to (E) in a trace amount and the liquid food product and the powder for food products are included in a water-containing chocolate in a trace amount. Thus, such a carbohydrate has no effect on the characteristics of a water-containing chocolate.

Examples of the dairy product include fresh cream, butter, milk, concentrated milk, skim milk powder, whole milk powder, modified milk powder, condensed milk, cheese cream, whipping cream, coffee cream, and the like. Among them, fresh cream and butter are preferably used from the viewpoint of flavor.

Usable examples of the acidulant include acidulants capable of being added to food products, such as citric acid, malic acid, tartaric acid, lactic acid, acetic acid, phytic acid, and the like. Adding the acidulant or fruit juice containing the acidulant can further suppress unpleasant sweetness due to a sugar alcohol. The amount of the acidulant is not particularly limited and is preferably an amount to cause the water phase component to have a pH of 3.0 to 6.5 and more preferably an amount to cause the water phase component to have a pH of 3.5 to 5.0. For an acidic condition in the pH range, the acidulant is preferably used in combination with a flavor, for example, flavors of citrus fruits such as orange, lemon, Citrus junos, lime, grapefruit and the like, flavors of berries such as blueberry, strawberry, raspberry (framboise) and the like, an apple flavor, a passion fruit flavor, a mango flavor and the like, from the viewpoint of food flavor.

Examples of the antimicrobial agent include glycyrrhiza extract, green tea extract such as catechin, bamboo grass extract, tannin, lysozyme, and the like. A bitter component such as catechin is generally known to have an effect of suppressing sweetness and thus may be used not only for improving preservability but also for further suppressing unpleasant sweetness of a sugar alcohol. The amount of the antimicrobial agent is not particularly limited but is preferably about 0.01 to 0.5% by weight based on the total amount of the water-containing chocolate from the viewpoint of not affecting the flavor of the water-containing chocolate.

The emulsifier may be any emulsifier for food products and examples include monoglyceride, organic acid monoglyceride, polyglycerol fatty acid ester, sucrose fatty acid ester, propylene glycol fatty acid ester, sorbitan fatty acid ester, lecithin, and the like. The emulsifier is preferably used in an amount of 0.01% by weight or more based on the total amount of the water-containing chocolate and within a range not affecting the flavor.

Examples of the salt include sodium chloride, potassium chloride, magnesium chloride, magnesium carbonate, and the like. The various salts are generally known to have a large effect of reducing water activity and is preferably added within a range not affecting the flavor. However, a salt added within a range not affecting the flavor is hardly expected to provide the effect of reducing water activity.

Examples of the foreign liquor include ethanol, rum, brandy, various liquors, and the like. A foreign liquor in which alcohol is not volatilized is added preferably after the water phase component and the oil phase component are mixed. The amount of the foreign liquor is preferably 0.1 to 5% by weight based on the total amount of the water-containing chocolate.

The water phase component can be obtained, for example, by dissolving, in water, two or more carbohydrates selected from the carbohydrates (A) to (E), as necessary, at least one substance selected from carbohydrates except the carbohydrates (A) to (E), various liquid food products capable of being added to food products and powders for food products capable of being dissolved in the water phase component in respective predetermined amounts and, as necessary, heating the obtained solution and/or adding water to the obtained solution, thereby adjusting the water content and the water activity.

The oil phase component in the water-containing chocolate of the present invention mainly includes chocolate. Examples of the chocolate used in the present invention include chocolate dough obtained by using cacao mass, cacao powder, carbohydrates such as sucrose, powdered milk, oil and fat, and other ingredients, rolling those ingredients in a usual manner, and if desired, subjecting to conching and a cacao raw material itself such as cacao mass, cacao powder, cacao butter, and the like.

The oil phase component in the water-containing chocolate of the present invention may further include, in addition to the chocolate, a material substantially including little water, for example, having a water content of about 1 to 2% by weight. Examples of such a material include various oils and fats including cocoa butter equivalent used in place of cacao butter and paste materials obtained by grinding a solid material rich in oil and fat, such as peanuts, almonds, hazelnuts, pistachios, sesames, and the like. Carbohydrates such as sucrose and lactose included in the oil phase component basically have no effect on the water activity of a water-containing chocolate and thus are not included in the amount of carbohydrates in the water-containing chocolate.

The cocoa butter equivalent is used in place of some or all of cacao butter for the purpose of improvement in the chocolate property and reduction in the production cost and typically includes a cocoa butter equivalent called CBE rich in 1,3-saturated-2-unsaturated triglyceride oil and fat, a lauric cocoa butter equivalent called CBR, and a cocoa butter equivalent highly containing elaidic acid. Examples of the oil and fat material for the cocoa butter equivalent include vegetable oils and fats such as rapeseed oil, soybean oil, sunflower oil, cottonseed oil, peanut oil, rice bran oil, corn oil, sunflower oil, olive oil, kapok oil, sesame oil, evening primrose oil, palm oil, shea fat, sal fat, coconut oil, palm kernel oil, and the like; and animal oils and fats such as cream, beef tallow, lard, fish oil, whale oil, and the like. Such an oil and fat, a mixed oil of two or more oils and fats selected from these oils and fats, and a processed oil and fat obtained by subjecting such an oil and fat or the mixed oil to hardening, fractionation, transesterification, or other treatments may be used.

The water-containing chocolate of the present invention can be obtained by emulsifying the water phase component and the oil phase component into an oil-in-water emulsion. The mixing ratio of the water phase component and the oil phase component is not particularly limited and is appropriately selected depending on the amount of two or more carbohydrates selected from the carbohydrates (A) to (E), the water content, the water activity, and other factors in the water phase component. The oil phase component is preferably used in an amount of 10 to 100 parts by weight with respect to 100 parts by weight of the water phase component. Examples of the method of emulsification into an oil-in-water emulsion include, but are not necessarily limited to, a method of adding the oil phase component to the water phase component, a method of adding the water phase component to the oil phase component, and Santos emulsification method in which the water phase component is gradually added to the oil phase component, thereby changing the structure step-by-step from the formation of a water-in-oil emulsion structure, then separation of the emulsion structure, and to the formation of an oil-in-water emulsion structure.

Examples of the method for judgment whether the oil-in-water emulsion structure is finally formed or not naturally include visual examination of a state and further include a method of using a simple apparatus such as an ammeter to ascertain electric conductivity. For the emulsification, any tools and machines conventionally used for the emulsification of food products can be used and examples include tools such as a whisk and machines such as a stick mixer and a homogenizer.

The water-containing chocolate of the present invention obtained in this manner preferably has a water content of 12 to 20% by weight. The water content of the water-containing chocolate of the present invention is determined from the water content of the water phase component and the mixing ratio of the water phase component and the oil phase component. In a water-containing chocolate having a water content of less than 12% by weight, it may be difficult to form an oil-in-water emulsion structure. Even if the emulsion structure can be formed, such a water content may impair the taste of the water-containing chocolate, for example, a starch syrup-like texture remains. Whereas, a water content of more than 20% by weight may lead to a water activity of more than 0.60 to deteriorate the preservability. A water-containing chocolate even having a water content of more than 20% by weight can be made to have a water activity of less than 0.60, depending on the total content [X] of carbohydrates in the water activity reducing agent. This improves preservability but the flavor of such a water-containing chocolate has a room for improvement.

In a particularly preferred embodiment of the water-containing chocolate of the present invention, the proportion [Z] of the total content [X] of carbohydrates in the water activity reducing agent with respect to the water content [Y] is 160 to 200% by weight and the water activity is less than 0.60. A water-containing chocolate even having a water content [Y] of, for example, 15% by weight or more but having a proportion [Z] ranging from 160 to 200% by weight can be easily made to have a water activity of less than 0.60 and such a water-containing chocolate obtains moderate sweetness to have preferred flavor.

A water-containing chocolate even having a proportion [Z] of less than 160% by weight can be made to have a water activity of less than 0.60 depending on the water content. However, the proportion [Z] is preferably 160 to 200% by weight in consideration of texture, flavor such as sweetness, and the like. A water-containing chocolate having a proportion [Z] of more than 200% by weight can be easily made to have a water activity of less than 0.60 but such a water-containing chocolate is likely to have excess sweetness. In a water-containing chocolate having a proportion [Z] ranging from 160 to 180% by weight, a water activity reducing agent [4] added to the water-containing chocolate preferably has a content [E] of 7.5% by weight or more and the sum of the content [C] and the content [D] is preferably 40% by weight or more.

In the water-containing chocolate of the present invention, the total content [X] of carbohydrates in the water activity reducing agent is preferably 25 to 45% by weight, more preferably 25 to 40% by weight, and even more preferably 25 to 35% by weight. In particular, a water activity reducing agent having a total content [X] of carbohydrates of 25 to 35% by weight has a remarkable effect of reducing the water activity to less than 0.60 and can further improve the flavor of the water-containing chocolate. A water-containing chocolate even including an additional carbohydrate except the carbohydrates (A) to (E) but having a total content [X] of less than 25% by weight has an insufficient effect of reducing water activity. In such a water-containing chocolate, it may be difficult to adjust the water activity to less than 0.60. A total content [X] of more than 45% by weight may increase unpleasant sweetness derived from a sugar alcohol thus to impair the flavor of a water-containing chocolate.

In a water-containing chocolate including the water activity reducing agent and including an additional carbohydrate except the carbohydrates (A) to (E) in combination with two or more carbohydrates selected from the carbohydrates (A) to (E), the amount of the whole carbohydrates in the water-containing chocolate is not particularly limited but is preferably 25 to 70% by weight, more preferably 30 to 50% by weight, and even more preferably 35 to 45% by weight. In a water-containing chocolate even including no additional carbohydrate but having a content of the whole carbohydrates of less than 25% by weight, it may be difficult to adjust the water activity to less than 0.60. A content of the whole carbohydrates of more than 70% by weight may excessively increase sweetness thus to impair the flavor of a water-containing chocolate.

The texture of the water-containing chocolate of the present invention is basically affected by the water content and the oil and fat content. A water-containing chocolate having a higher water content or having a lower oil and fat content has smoother texture and better meltability in the mouth. However, such a water-containing chocolate has high flowability and thus has poor shape retention ability. Examples of the oil and fat included in the water-containing chocolate of the present invention include the oil and fat derived from a dairy product included in the water phase component and the oil and fat in cacao butter or other ingredients included in the oil phase component. The amount of the oil and fat in the water-containing chocolate of the present invention is preferably 8 to 20% by weight based on the total amount of the water-containing chocolate and more preferably 10 to 15% by weight based on the total amount of the water-containing chocolate. An oil and fat content of less than 8% by weight may reduce the shape retention ability of the water-containing chocolate and such a water-containing chocolate may be difficult to be handled except filling. An oil and fat content of more than 20% by weight may impair the smooth texture and good meltability in the mouth of the water-containing chocolate.

The water-containing chocolate of the present invention after solidification may be cut into a desired shape and then coated with cocoa powder into, for example, soft chocolate or then coated with chocolate into, for example, bon bon chocolate. The water-containing chocolate after solidification may further be aerated with a hand mixer or other tools to yield a water-containing chocolate containing air. The water-containing chocolate may be combined with not only chocolate but also various confectioneries such as soft candies baked sweets, and the like.

### EXAMPLES

The present invention will next be described in detail with reference to Reference Examples, Examples, and Comparative Examples but the invention is not intended to be limited to these examples. In Examples below, “part” and “%” mean “part by weight” and “% by weight”, respectively, unless otherwise specified.

The water activity was determined using a water activity instrument with a constant temperature chamber (trade name: LabMASTER-aw BASIC, manufactured by novasina) in a condition at 25° C.

### Reference Examples 1 to 6

First, as control, the water activity (Aw) of each aqueous solution of sorbitol (A), glucose (B), xylitol (C), erythritol (D), glycerin (E), and fructose (F) was determined in various solid content ratios (hereinafter called “solid contents”). (A) to (F) are indicated by Reference Examples 1 to 6, respectively. Erythritol (D) in Reference Example 4 crystallizes at a solid content of 40% that is a condition including water in a large amount, and thus the water activity could not be determined.

First, each powdered or liquid carbohydrate material was mixed with water and the mixture was heated to be completely dissolved, thereby yielding a corresponding aqueous solution. Subsequent heating of the aqueous solution allowed water to volatilize from the aqueous solution. A sample was taken at any step and the water activity and the water content of the sample was sequentially determined. Even if water is added to an aqueous solution after volatilizing water to some extent and then a sample is taken, the measured values of the water activity and water content are not affected. FIG. 1 and FIG. 2 show the results. In FIG. 1 and FIG. 2, the horizontal axis represents solid content, which is a value obtained by subtracting a determined water content from 100.

FIG. 1 is a graph showing the relation between a solid content (%) and a water activity in each aqueous solution of sorbitol (▪), xylitol (▴), and glycerin (). FIG. 2 is a graph showing the relation between a solid content (%) and a water activity in each aqueous solution of sorbitol (▪), glucose (x), and fructose (⋄).

As apparent from FIG. 1, xylitol had a smaller water activity than that of sorbitol in a solid content region to 70% but the water activity of xylitol was greatly increased as the solid content increased over the region. This is supposed to be because xylitol crystallizes. Glycerin having the smallest molecular weight had a smaller water activity than those of xylitol and sorbitol. As apparent from FIG. 2, glucose alone and fructose alone had similar water activities and sorbitol having the almost same molecular weight as those of glucose and fructose showed a small water activity especially in a small water content region. From FIG. 1 and FIG. 2, sorbitol, xylitol, glycerin, glucose, and fructose are supposed to have a water activity of about 0.637, 0.675, 0.570, 0.665, and 0.663, respectively, at a solid content of 75%.

### Examples 1 to 3 and Comparative Examples 1 to 3

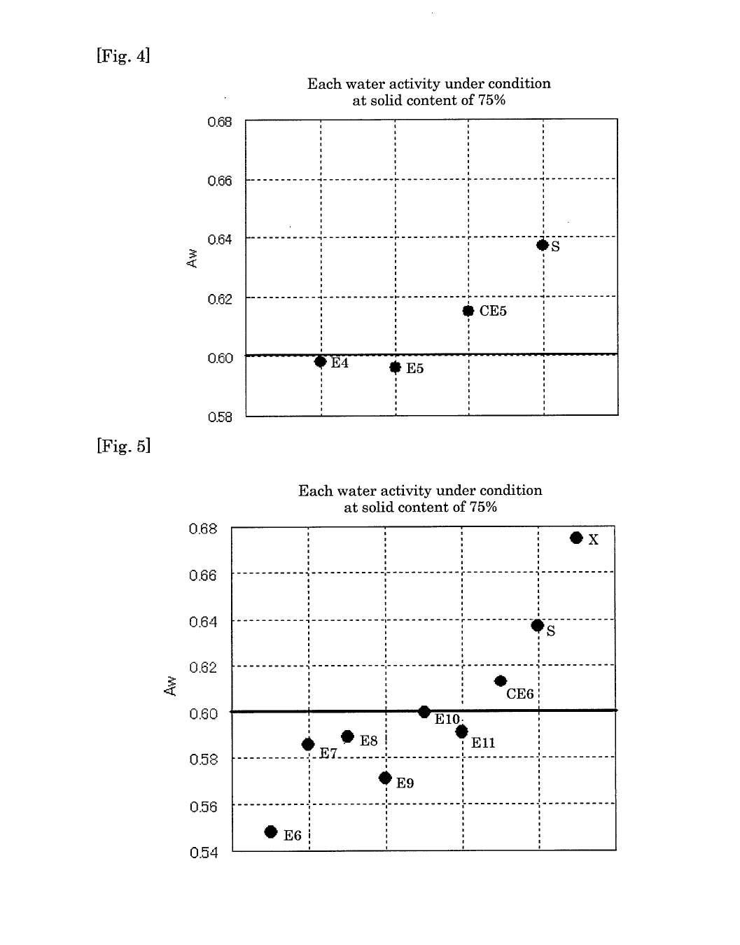

Next, a similar measurement was carried out on Examples 1 to 3 of the water activity reducing agents of the present invention including two sugar alcohols of sorbitol and xylitol and on Comparative Examples 1 to 3. Table 1 shows the formulations of Examples 1 to 3 and Comparative Examples 1 to 3 and the results of water activity. The water activity of each water activity reducing agent of Examples 1 to 3 and Comparative Examples 1 to 3 was determined at a solid content of 75% and the results are shown in FIG. 3. FIG. 3 is a graph showing the water activity of each aqueous solution of the water activity reducing agents of Examples 1 to 3 and Comparative Examples 1 to 3, sorbitol (S), and xylitol (X) at a solid content of 75%. In FIG. 3, “E1” to “E3” represent Examples 1 to 3, respectively, “CE1” to “CE3” represent Comparative Examples 1 to 3, respectively, “S” represents sorbitol alone, and “X” represents xylitol alone. On the horizontal axis, data are arranged at equal intervals and the horizontal axis represents no formulation ratio. The horizontal axes in FIGS. 4 to 9 are as with the above for FIG. 3.

TABLE 1

| | | | | | | Comparative | | Comparative | | Comparative | |
|---|---|---|---|---|---|---|---|---|---|---|---|
| Example 1 | | Example 2 | | Example 3 | | Example 1 | | Example 2 | | Example 3 | |
| Sorbitol 25% | | Sorbitol 33% | | Sorbitol 50% | | Sorbitol 60% | | Sorbitol 67% | | Sorbitol 75% | |
| Xylitol 75% | | Xylitol 67% | | Xylitol 50% | | Xylitol 40% | | Xylitol 33% | | Xylitol 25% | |
| Solid content | Aw | Solid content | Aw | Solid content | Aw | Solid content | Solid content | Solid content | Aw | Solid content | Aw |
| 61.8 | 0.775 | 66.6 | 0.723 | 51.2 | 0.857 | 60.3 | 0.806 | 62.6 | 0.792 | 59.1 | 0.828 |
| 67.2 | 0.720 | 71.0 | 0.665 | 58.2 | 0.815 | 69.1 | 0.730 | 67.7 | 0.738 | 66.7 | 0.759 |
| 70.7 | 0.673 | 74.4 | 0.605 | 67.1 | 0.732 | 72.4 | 0.666 | 70.0 | 0.691 | 72.0 | 0.688 |
| 73.4 | 0.623 | 75.9 | 0.561 | 71.8 | 0.660 | 78.7 | 0.568 | 72.2 | 0.681 | 78.7 | 0.556 |
| 76.9 | 0.540 | 79.3 | 0.474 | 74.6 | 0.602 | 79.9 | 0.504 | 76.0 | 0.611 | 82.2 | 0.460 |
| 79.5 | 0.498 | 79.5 | 0.472 | 77.3 | 0.549 | 81.1 | 0.509 | 80.0 | 0.560 | | |
| | | | | 82.8 | 0.433 | | | 83.2 | 0.453 | | |

As apparent from Table 1 and FIG. 3, the water activity values are greatly different between Examples 1 to 3 and Comparative Examples 1 to 3 and this suggests the possibility of an inflection point around a water activity of 0.61. Each of Examples 1 to 3 had a water activity of less than 0.60 at a solid content of 75% and in such an environment, microorganisms can fail to proliferate. This value is completely revolutionary in a condition of a water content of 25%.

### Examples 4 and 5 and Comparative Examples 4 and 5

In a similar manner to that in Examples 1 to 3 and Comparative Examples 1 to 3, the relation between the solid content and the water activity was examined on Examples 4 and 5 of the water activity reducing agents of the present invention including two sugar alcohols of sorbitol and erythritol and Comparative Examples 4 and 5 of water activity reducing agents for reference. Table 2 and FIG. 4 show the results. FIG. 4 is a graph showing the water activity of each aqueous solution of the water activity reducing agents of Examples 4 and 5 and Comparative Example 5 and sorbitol (S) at a solid content of 75%. In FIG. 4, “E4” and “E5” represent Examples 4 and 5, respectively, “CE5” represents Comparative Example 5, and “S” represents sorbitol alone.

TABLE 2

| | | | | Comparative | | Comparative | |
|---|---|---|---|---|---|---|---|
| Example 4 | | Example 5 | | Example 4 | | Example 5 | |
| Sorbitol 67% | | Sorbitol 80% | | Sorbitol 50% | | Sorbitol 90% | |
| Erythritol 33% | | Erythritol 20% | | Erythritol 50% | | Erythritol 10% | |
| Solid content | Aw | Solid content | Aw | Solid content | Aw | Solid content | Aw |
| 64.8 | 0.748 | 50.6 | 0.853 | 65.1 | 0.726 | 60.3 | 0.806 |

| | | | | | | |
|---|---|---|---|---|---|---|
| 73.0 | 0.651 | 56.9 | 0.832 | Not determined | 69.1 | 0.730 |
| 77.2 | 0.539 | 59.1 | 0.806 | due to crystal | 79.9 | 0.504 |
| 81.5 | 0.432 | 68.9 | 0.702 | precipitation | 81.1 | 0.509 |
| | | 74.8 | 0.600 | | | |

As apparent from Table 2 and FIG. 4, Examples 4 and 5 of the present invention had a water activity of less than 0.60 at a solid content of 75%, whereas Comparative Example 5 having a high sorbitol content had a water activity of 0.615 at a solid content of 75%. In Comparative Example 4 having a high erythritol content, erythritol crystallized before the aqueous solution of the water activity reducing agent obtained a solid content of 75% and thus the water activity could not be determined.

### Examples 6 to 11 and Comparative Examples 6 to 9

In a similar manner to that in Examples 1 to 3 and Comparative Examples 1 to 3, each water activity was determined on Examples 6 to 11 of three-component water activity reducing agents including three sugar alcohols of sorbitol, xylitol, and erythritol and Comparative Examples 6 to 9 of water activity reducing agents for reference at a solid content of 75%. Table 3, Table 4, and FIG. 5 show the results. FIG. 5 is a graph showing the water activity of each aqueous solution of the water activity reducing agents of Examples 6 to 11 and Comparative Example 6, sorbitol (S), and xylitol (X) at a solid content of 75%. In FIG. 5, “E6” to “E11” represent Examples 6 to 11, respectively, “CE6” represents Comparative Example 6, “S” represents sorbitol alone, and “X” represents xylitol alone.

TABLE 3

| Example 6 | | Example 7 | | Example 8 | | Example 9 | | Example 10 | | Example 11 | |
|---|---|---|---|---|---|---|---|---|---|---|---|
| Sorbitol 25% | | Sorbitol 20% | | Sorbitol 60% | | Sorbitol 60% | | Sorbitol 70% | | Sorbitol 80% | |
| Xylitol 50% | | Xylitol 55% | | Xylitol 27.5% | | Xylitol 15% | | Xylitol 20.6% | | Xylitol 5% | |
| Erythritol 25% | | Erythritol 25% | | Erythritol 12.5% | | Erythritol 25% | | Erythritol 9.4% | | Erythritol 15% | |
| Solid content | Aw | Solid content 57.5 | Aw | Solid content | Aw | Solid content | Aw | Solid content | Aw | Solid content | Aw |
| 59.2 | 0.790 | | 0.795 | 51.4 | 0.852 | 51.9 | 0.841 | 50.9 | 0.860 | 49.8 | 0.864 |
| 62.7 | 0.763 | 61.9 | 0.750 | 57.6 | 0.818 | 57.5 | 0.809 | 62.3 | 0.787 | 63.0 | 0.776 |
| 65.4 | 0.736 | 73.5 | 0.633 | 63.9 | 0.762 | 64.5 | 0.741 | 66.4 | 0.737 | 68.8 | 0.707 |
| 67.7 | 0.694 | 80.0 | 0.430 | 70.0 | 0.680 | 71.5 | 0.642 | 67.6 | 0.720 | 75.4 | 0.583 |
| 70.5 | 0.646 | 82.6 | 0.289 | 75.3 | 0.584 | 79.3 | 0.483 | 76.0 | 0.583 | 80.6 | 0.450 |
| 77.2 | 0.500 | | | 79.6 | 0.485 | | | 83.3 | 0.402 | | |
| 80.0 | 0.439 | | | | | | | | | | |

TABLE 4

| Comparative | | Comparative | | Comparative | | Comparative | |
|---|---|---|---|---|---|---|---|
| Example 6 | | Example 7 | | Example 8 | | Example 9 | |
| Sorbitol 85% | | Sorbitol 15% | | Sorbitol 40% | | Sorbitol 20% | |
| Xylitol 5% | | Xylitol 60% | | Xylitol 30% | | Xylitol 40% | |
| Erythritol 10% | | Erythritol 25% | | Erythritol 30% | | Erythritol 40% | |
| Solid content | Aw | Solid content | Aw | Solid content | Aw | Solid content | Aw |
| 58.8 | 0.811 | 57.5 | 0.788 | 52.9 | 0.818 | 57.0 | 0.791 |
| 64.9 | 0.761 | 62.8 | 0.728 | 57.1 | 0.799 | 61.3 | 0.750 |

| | | | | | | |
|---|---|---|---|---|---|---|
| 71.0 | 0.683 | 71.4 | 0.582 | Not determined | 67.2 | 0.655 |

| | | | | |
|---|---|---|---|---|
| 76.2 | 0.592 | Not determined | due to crystal | Not determined |
| | | due to crystal | precipitation | due to crystal |
| | | precipitation | | precipitation |

As apparent from Tables 3 and 4 and FIG. 5, each of Examples 6 to 11 had a water activity of less than 0.60 at a solid content of 75%, whereas Comparative Example 6 having a high sorbitol content had a water activity of more than 0.60 at a solid content of 75%. In each of Comparative Example 7 having a low sorbitol content and Comparative Examples 8 and 9 having a high erythritol content, the crystal precipitated before the solid content reached 75%.

### Example 12 and Comparative Examples 10 and 11

In order to examine the effect of the water activity reducing agent of the present invention included in a food product, baked sweets of Example 12 and Comparative Examples 10 and 11 were prepared. Each ingredient shown in Table 5 was used in an amount (g) shown in Table 5. First, ingredients except medium-strength flour and meringue were mixed and emulsified using a whisk. To the obtained emulsified mixture, medium-strength flour sieved was added while not getting lumpy and then meringue was mixed, thus preparing cake dough. The cake dough was poured into a mold having a thickness of 2 cm and was baked in an oven at 160° C. for 25 minutes to yield a baked sweet. The water activity reducing agent described in Table 5 was obtained by dissolving the water activity reducing agent of Example 6 in water to adjust Bx (=solid content) to 70.

TABLE 5

| | | Amount (g) | | |
|---|---|---|---|---|
| | | Example | Comparative | Comparative |
| Ingredient name | | 12 | Example 10 | Example 11 |
| Sucrose syrup (Bx70) | | 0 | 0 | 20 |
| Sorbitol solution (Bx70) | | 0 | 20 | 0 |
| Water activity reducing agent | | 20 | 0 | 0 |
| (Bx70) | | | | |
| Egg yolk | | 25 | 25 | 25 |
| Salad oil | | 20 | 20 | 20 |
| Milk | | 37.5 | 37.5 | 37.5 |
| Medium-strength flour | | 40 | 40 | 40 |
| Meringue | Egg albumen | 50 | 50 | 50 |
| | Dried egg albumen | 0.2 | 0.2 | 0.2 |
| | Sucrose | 20 | 20 | 20 |

As a result of the measurement of the water activity in each baked sweet of Example 12, Comparative Example 10, and Comparative Example 11, the water activities of Example 12, Comparative Example 10, and Comparative Example 11 were 0.862, 0.885, and 0.900, respectively. The water content of each of Examples was about 28%. From these results, the water activity reducing agent of the present invention is believed to work effectively even included in a food product having a water content of more than 25%.

### Example 13 and Comparative Examples 12 and 13

Using each ingredient shown in Table 6 in an amount (g) shown in Table 6, guimauve (marshmallow) was prepared. Here, the maltose syrup (Bx 75) is a syrup mainly including maltose and a commercial product (trade name: High Maltose M70, manufactured by Nihon Cornstarch Co.) was used.

First, each ingredient in the syrup part described in Table 6 was mixed with an appropriate amount of water and the mixture was heated, thereby completely dissolving the ingredients in water. The obtained aqueous solution of the ingredients was heated and water was volatilized. The solution was concentrated until Bx reached 75, thus yielding a syrup having a Bx of 75. Separately, gelatin (250 bloom) was swelled with water in 1.4 times the weight of gelatin, thus preparing a gelatin solution.

Next, 80 g of the syrup having a Bx of 75 obtained above was mixed with 4.0 g of the gelatin solution obtained above and 0.1 g of flavor. The mixture was aerated with a hand mixer and then was filled in starch, thereby yielding each guimauve of Example 13 and Comparative Examples 12 and 13.

Each water activity of the syrups having a Bx of 75 and the guimauves of Example 13 and Comparative Examples 12 and 13 was determined. The guimauve before filled in starch was used for the measurement of water activity. The water content and the sugar alcohol content of each guimauve of Example 13 and Comparative Examples 12 and 13 were determined. Table 6 shows the results.

TABLE 6

| | | | | Comparative | Comparative |
|---|---|---|---|---|---|
| | Ingredient name | | Example 13 | Example 12 | Example 13 |
| Amount (g) | Syrup part | Sucrose | 10 | 10 | 35 |
| | | Maltose syrup (Bx75) | 0 | 0 | 35 |
| | | Sorbitol | 15 | 60 | 0 |
| | | Xylitol | 30 | 0 | 0 |
| | | Erythritol | 15 | 0 | 0 |
| | | Concentrated apple | 10 | 10 | 10 |
| | | juice (Bx70) | | | |

| | Syrup (Bx75) | 80 | 80 | 80 |
|---|---|---|---|---|
| | Gelatin solution | 4.0 | 4.0 | 4.0 |
| | Flavor | 0.10 | 0.10 | 0.10 |
| Physical | Water activity of syrup part | 0.542 | 0.638 | 0.771 |
| properties | Water activity of guimauve | 0.534 | 0.612 | 0.727 |
| | Water content (%) | 22.5% | 21.8% | 21.5% |
| | Sugar alcohol content (%) | 56% | 56% | 0% |

As apparent from Table 6, Example 13 using the water activity reducing agent of the present invention showed a high water content of 22.5% but a very low water activity. In contrast, each of Comparative Example 12 and Comparative Example 13 had a water activity of 0.60 or more. In particular, the difference of the water activity between Example 13 and Comparative Example 12 using sorbitol resulted in about 0.08. Each guimauve of Example 13 and Comparative Example 12 was tasted by six panelists. All panelists evaluated that the guimauve of Example 13 had less unpleasant sweetness. These results reveal that the water activity reducing agent of the present invention has high effect, does not impair the flavor of a food product, and thus is highly useful.

### Examples 14 to 18 and Comparative Examples 14 to 17

Sorbitol, glucose, and xylitol were mixed in a ratio (%) shown in Table 7 to yield the water activity reducing agents of Examples 14 to 18 and Comparative Examples 14 to 17. Next, each water activity reducing agent of Examples 14 to 18 and Comparative Examples 14 to 17 was dissolved in water in a solid content shown in Table 7 and the water activity of each solution was determined. Table 7 shows the results. Table 7 shows the content [C] in each water activity reducing agent.

FIG. 6 shows the water activity of each water activity reducing agent of Examples 14 to 18 and Comparative Examples 14 to 17 at a solid content of 75%. FIG. 6 is a graph showing the water activity of each aqueous solution of Examples 14 to 18, Comparative Examples 14 to 17, sorbitol (S), glucose (Gu), and xylitol (X) at a solid content of 75%. In FIG. 6, “E14” to “E18” represent Examples 14 to 18, respectively, “CE14” to “CE17” represent Comparative Examples 14 to 17, respectively, “S” represents sorbitol alone, “Gu” represents glucose alone, and “X” represents xylitol alone.

TABLE 7

| Example 14 | | Example 15 | | Example 16 | | Example 17 | | Example 18 | |
|---|---|---|---|---|---|---|---|---|---|
| Sorbitol 25% | | Sorbitol 33% | | Sorbitol 50% | | Sorbitol 0% | | Sorbitol 25% | |
| Glucose 0% | | Glucose 0% | | Glucose 0% | | Glucose 50% | | Glucose 25% | |
| Xylitol 75% | | Xylitol 67% | | Xylitol 50% | | Xylitol 50% | | Xylitol 50% | |
| [C] 75% | | [C] 67% | | [C] 50% | | [C] 50% | | [C] 50% | |
| Solid content | Aw | Solid content | Aw | Solid content | Aw | Solid content | Aw | Solid content | Aw |
| 61.8 | 0.775 | 66.6 | 0.723 | 51.2 | 0.857 | 51.6 | 0.852 | 51.8 | 0.852 |
| 67.2 | 0.720 | 71.0 | 0.665 | 58.2 | 0.815 | 58.1 | 0.817 | 58.0 | 0.817 |
| 70.7 | 0.673 | 74.4 | 0.605 | 67.1 | 0.732 | 59.2 | 0.806 | 65.2 | 0.750 |
| 73.4 | 0.623 | 75.9 | 0.561 | 71.8 | 0.660 | 63.4 | 0.771 | 68.3 | 0.713 |
| 76.9 | 0.540 | 79.3 | 0.474 | 74.6 | 0.602 | 68.1 | 0.716 | 72.0 | 0.653 |
| 79.5 | 0.498 | 79.5 | 0.472 | 77.3 | 0.549 | 75.9 | 0.582 | 75.3 | 0.590 |
| | | | | 82.8 | 0.433 | | | | |

| Comparative | | Comparative | | Comparative | | Comparative | |
|---|---|---|---|---|---|---|---|
| Example 14 | | Example 15 | | Example 16 | | Example 17 | |
| Sorbitol 60% | | Sorbitol 67% | | Sorbitol 75% | | Sorbitol 0% | |
| Glucose 0% | | Glucose 0% | | Glucose 0% | | Glucose 75% | |
| Xylitol 40% | | Xylitol 33% | | Xylitol 25% | | Xylitol 25% | |
| [C] 40% | | [C] 33% | | [C] 25% | | [C] 25% | |
| Solid content | Aw | Solid content | Aw | Solid content | Aw | Solid content | Aw |
| 60.3 | 0.806 | 62.6 | 0.792 | 59.1 | 0.828 | 52.1 | 0.857 |
| 69.1 | 0.730 | 67.7 | 0.738 | 66.7 | 0.759 | 56.8 | 0.845 |
| 72.4 | 0.666 | 70.0 | 0.691 | 72.0 | 0.688 | 60.3 | 0.814 |
| 78.7 | 0.568 | 72.2 | 0.681 | 78.7 | 0.556 | 63.4 | 0.788 |
| 79.9 | 0.504 | 76.0 | 0.611 | 82.2 | 0.460 | 71.3 | 0.694 |
| 81.1 | 0.509 | 80.0 | 0.560 | | | 74.8 | 0.641 |
| | | 83.2 | 0.453 | | | 78.4 | 0.566 |

As apparent from FIG. 6, each water activity of Examples 14 to 18 at a solid content of 75% greatly differs from each water activity of Comparative Examples 14 to 17 at a solid content of 75%. The comparison of Examples 14 to 16 with Comparative Examples 14 to 16 suggests the possibility of an inflection point around a water activity of 0.61. Examples 16 to 18 had substantially the same water activity from comparison and this reveals that glucose and sorbitol can be replaced to each other. Each of Examples 14 to 18 had a water activity of less than 0.60 at a solid content of 75% and in such an environment, microorganisms can fail to proliferate. This value is completely revolutionary in a condition of a water content of 25% by weight.

### Examples 19 to 22 and Comparative Examples 18 to 20

Sorbitol, glucose, and erythritol were mixed in a ratio (%) shown in Table 8 to yield the water activity reducing agents of Examples 19 to 22 and Comparative Examples 18 to 20. Next, each water activity reducing agent of Examples 19 to 22 and Comparative Examples 18 to 20 was dissolved in water in a solid content shown in Table 8 and the water activity of each solution was determined. Table 8 shows the results. Table 8 shows the content [D] in each water activity reducing agent.

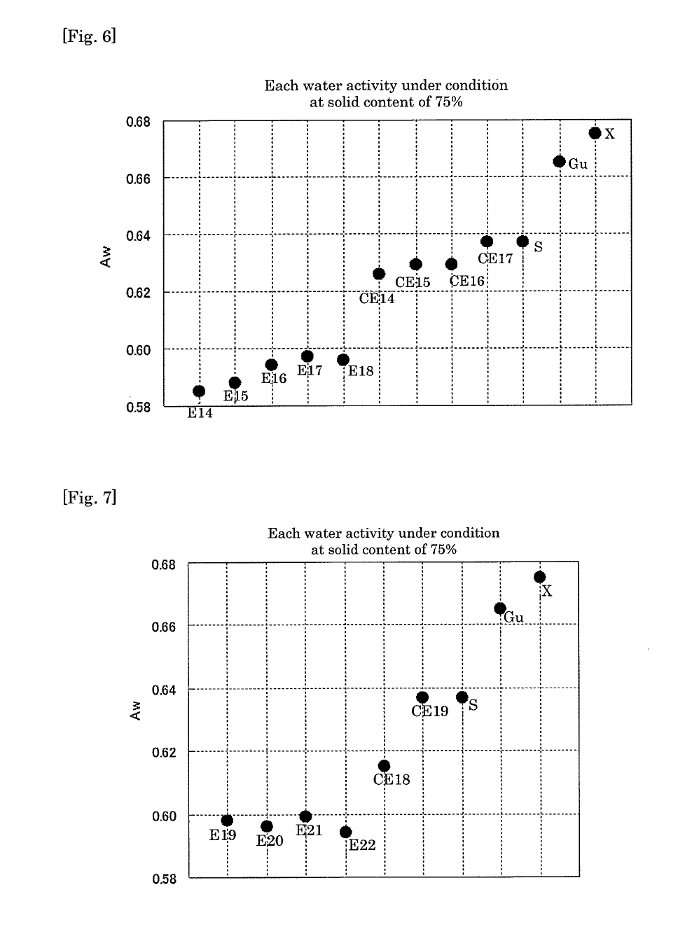

FIG. 7 shows the measurement result of the water activity of each water activity reducing agent of Examples 19 to 22 and Comparative Examples 19 and 20 at a solid content of 75%. FIG. 7 is a graph showing the water activity of each aqueous solution of Examples 19 to 22, Comparative Examples 19 and 20, sorbitol (S), glucose (Gu), and xylitol (X) at a solid content of 75%. In FIG. 7, “E19” to “E22” represent Examples 19 to 22, respectively, “CE19” and “CE20” represent Comparative Examples 19 and 20, respectively, “S” represents sorbitol alone, “Gu” represents glucose alone, and “X” represents xylitol alone.

TABLE 8

| Example 19 | | Example 20 | | Example 21 | | Example 22 | |
|---|---|---|---|---|---|---|---|
| Sorbitol 67% | | Sorbitol 80% | | Sorbitol 0% | | Sorbitol 40% | |
| Glucose 0% | | Glucose 0% | | Glucose 80% | | Glucose 40% | |
| Erythritol 33% | | Erythritol 20% | | Erythritol 20% | | Erythritol 20% | |
| [D] 33% | | [D] 20% | | [D] 20% | | [D] 20% | |
| Solid content | Aw | Solid content | Aw | Solid content | Aw | Solid content | Aw |
| 64.8 | 0.748 | 50.6 | 0.853 | 52.0 | 0.851 | 51.0 | 0.852 |
| 73.0 | 0.651 | 56.9 | 0.832 | 57.9 | 0.821 | 55.5 | 0.835 |
| 77.2 | 0.539 | 59.1 | 0.806 | 63.3 | 0.772 | 60.3 | 0.796 |
| 81.5 | 0.432 | 68.9 | 0.702 | 68.8 | 0.701 | 65.2 | 0.744 |
| | | 74.8 | 0.600 | 78.3 | 0.545 | 72.1 | 0.647 |
| | | 81.7 | 0.444 | | | 77.3 | 0.552 |

| Comparative | | Comparative | | Comparative | |
|---|---|---|---|---|---|
| Example 18 | | Example 19 | | Example 20 | |
| Sorbitol 50% | | Sorbitol 90% | | Sorbitol 0% | |
| Glucose 0% | | Glucose 0% | | Glucose 90% | |
| Erythritol 50% | | Erythritol 10% | | Erythritol 10% | |
| [D] 50% | | [D] 10% | | [D] 10% | |
| Solid content | Aw | Solid content | Aw | Solid content | Aw |
| 65.1 | 0.726 | 52.9 | 0.848 | 52.7 | 0.858 |

| | | | | |
|---|---|---|---|---|
| Not determined | 60.1 | 0.806 | 57.3 | 0.839 |
| due to crystal | 67.0 | 0.742 | 65.8 | 0.763 |
| precipitation | 75.5 | 0.607 | 69.4 | 0.720 |
| | 82.3 | 0.462 | 73.0 | 0.674 |
| | | | 76.5 | 0.609 |

As apparent from FIG. 7, each of Examples 19 to 22 had a water activity of less than 0.60 at a solid content of 75% and Examples 20 to 22 had an almost equal water activity from comparison. This result reveals that glucose and sorbitol can be replaced to each other. In contrast, Comparative Example 19 having a high sorbitol content had a water activity of 0.615 at a solid content of 75%. In Comparative Example 18 having a high erythritol content, erythritol crystallized before the aqueous solution of the water activity reducing agent obtained a solid content of 75% and thus the water activity could not be determined.

### Examples 23 to 32 and Comparative Examples 21 to 25

Sorbitol (A), glucose (B), xylitol (C), and erythritol (D) were mixed in a ratio (%) shown in Table 9 to yield the water activity reducing agents of Examples 23 to 32 and Comparative Examples 21 to 25. In Comparative Example 25, a water activity reducing agent for reference was prepared in a similar manner to that in Example 30 except that fructose (F) was used in place of glucose (B). Next, each water activity reducing agent of Examples 23 to 32 and Comparative Examples 21 to 25 was dissolved in water in a solid content shown in Table 9 and the water activity of each solution was determined. Table 9 shows the results. Table 9 shows the total content [A] and [B] and the content [D] in each water activity reducing agent.

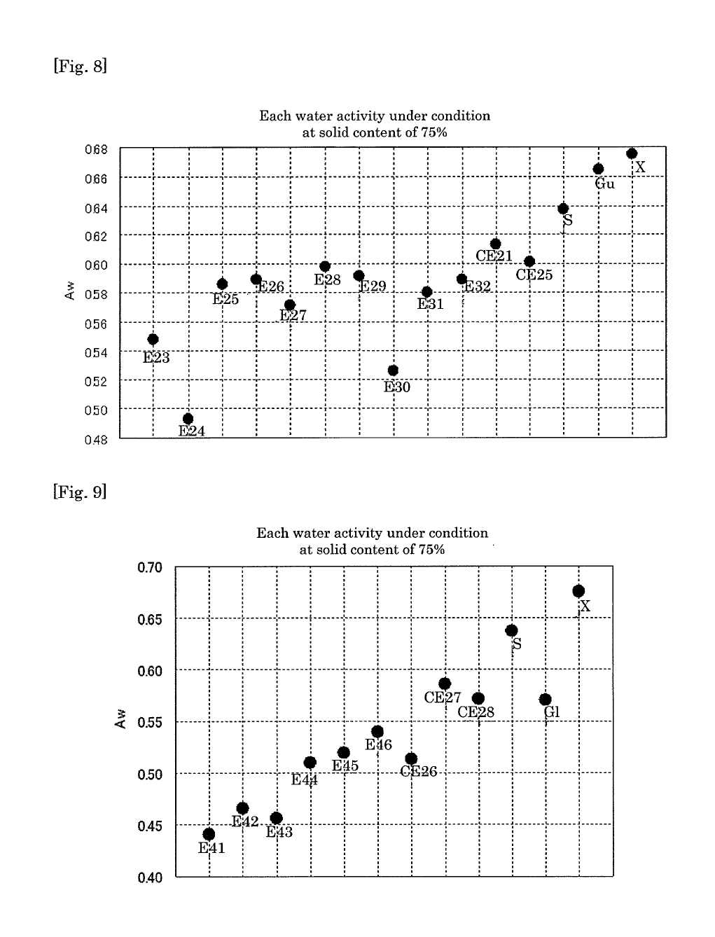

FIG. 8 shows the water activity of each aqueous solution of the water activity reducing agents of Examples 23 to 32 and Comparative Examples 21 and 25 at a solid content of 75%. FIG. 8 is a graph showing the water activity of each aqueous solution of Examples 23 to 32, Comparative Example 21 and 25, sorbitol (S), glucose (Gu), and xylitol (X) at a solid content of 75%. In FIG. 8, “E23” to “E32” represent Examples 23 to 32, respectively, “CE21” and “CE25” represent Comparative Examples 21 and 25, respectively, “S” represents sorbitol alone, “Gu” represents glucose alone, and “X” represents xylitol alone.

TABLE 9

| Example 23 | | Example 24 | | Example 25 | | Example 26 | | Example 27 | | Example 28 | |
|---|---|---|---|---|---|---|---|---|---|---|---|
| (A) 25% | | (A) 0% | | (A) 20% | | (A) 60% | | (A) 60% | | (A) 70% | |
| (B) 0% | | (B) 25% | | (B) 0% | | (B) 0% | | (B) 0% | | (B) 0% | |
| (C) 50% | | (C) 50% | | (C) 55% | | (C) 27.5% | | (C) 15% | | (C) 20.6% | |
| (D) 25% | | (D) 25% | | (D) 25% | | (D) 12.5% | | (D) 25% | | (D) 9.4% | |
| [A] + [B] 25% | | [A] + [B] 25% | | [A] + [B] 20% | | [A] + [B] 60% | | [A] + [B] 60% | | [A] + [B] 70% | |
| [D] 25% | | [D] 25% | | [D] 25% | | [D] 13% | | [D] 25% | | [D] 9.4% | |
| Solid content | Aw | Solid content | Aw | Solid content | Aw | Solid content | Aw | Solid content | Aw | Solid content | Aw |
| 59.2 | 0.790 | 48.2 | 0.867 | 57.5 | 0.795 | 51.4 | 0.852 | 51.9 | 0.841 | 50.9 | 0.860 |
| 62.7 | 0.763 | 49.0 | 0.857 | 61.9 | 0.750 | 57.6 | 0.818 | 57.5 | 0.809 | 62.3 | 0.787 |
| 65.4 | 0.736 | 58.2 | 0.784 | 73.5 | 0.633 | 63.9 | 0.762 | 64.5 | 0.741 | 66.4 | 0.737 |
| 67.7 | 0.694 | 63.8 | 0.709 | 80.0 | 0.430 | 70.0 | 0.680 | 71.5 | 0.642 | 67.6 | 0.720 |
| 70.5 | 0.646 | 70.7 | 0.567 | 82.6 | 0.289 | 75.3 | 0.584 | 79.3 | 0.483 | 76.0 | 0.583 |
| 77.2 | 0.500 | 75.1 | 0.491 | | | 79.6 | 0.485 | | | 83.3 | 0.402 |
| 80.0 | 0.439 | 82.3 | 0.364 | | | | | | | | |
| | | | | | | | | Comparative | | Comparative | |
| Example 29 | | Example 30 | | Example 31 | | Example 32 | | Example 21 | | Example 22 | |
| (A) 80% | | (A) 25% | | (A) 37.5% | | (A) 25% | | (A) 85% | | (A) 15% | |
| (B) 0% | | (B) 25% | | (B) 25% | | (B) 37.5% | | (B) 0% | | (B) 0% | |
| (C) 5% | | (C) 25% | | (C) 25% | | (C) 25% | | (C) 5% | | (C) 60% | |
| (D) 15% | | (D) 25% | | (D) 12.5% | | (D) 12.5% | | (D) 10% | | (D) 25% | |
| [A] + [B] 80% | | [A] + [B] 50% | | [A] + [B] 62.5% | | [A] + [B] 62.5% | | [A] + [B] 85% | | [A] + [B] 15% | |
| [D] 15% | | [D] 25% | | [D] 12.5% | | [D] 12.5% | | [D] 10% | | [D] 25% | |
| Solid content | Aw | Solid content | Aw | Solid content | Aw | Solid content | Aw | Solid content | Aw | Solid content | Aw |
| 49.8 | 0.864 | 49.9 | 0.861 | 58.1 | 0.813 | 51.6 | 0.853 | 58.8 | 0.811 | 57.5 | 0.788 |
| 63.0 | 0.776 | 57.5 | 0.813 | 63.4 | 0.765 | 57.8 | 0.817 | 64.9 | 0.761 | 62.8 | 0.728 |
| 68.8 | 0.707 | 59.5 | 0.777 | 66.4 | 0.725 | 63.9 | 0.761 | 71.0 | 0.683 | 71.4 | 0.582 |

| | | | | | | | | | | |
|---|---|---|---|---|---|---|---|---|---|---|
| 75.4 | 0.583 | 65.5 | 0.698 | 70.0 | 0.677 | 69.8 | 0.683 | 76.2 | 0.592 | Not determined |
| 80.6 | 0.450 | 73.2 | 0.558 | 73.3 | 0.625 | 73.3 | 0.630 | 81.8 | 0.464 | due to crystal |
| | | 79.1 | 0.453 | 74.8 | 0.586 | 74.8 | 0.593 | | | precipitation |
| | | 80.3 | 0.441 | 76.2 | 0.544 | 78.1 | 0.516 | | | |

| Comparative | | Comparative | | Comparative | |
|---|---|---|---|---|---|
| Example 23 | | Example 24 | | Example 25 | |
| (A) 40% | | (A) 20% | | (A) 25% | |
| (B) 0% | | (B) 0% | | (F) 25% | |
| (C) 30% | | (C) 40% | | (C) 25% | |
| (D) 30% | | (D) 40% | | (D) 25% | |
| [A] + [B] 40% | | [A] + [B] 20% | | [A] + [F] 50% | |
| [D] 30% | | [D] 40% | | [D] 25% | |
| Solid content | Aw | Solid content | Aw | Solid content | Aw |
| 52.9 | 0.818 | 57.0 | 0.791 | 61.7 | 0.786 |
| 57.1 | 0.799 | 61.3 | 0.750 | 67.4 | 0.722 |

| | | | | |
|---|---|---|---|---|
| Not determined | 67.2 | 0.655 | 73.7 | 0.627 |

| | | | |
|---|---|---|---|
| due to crystal | Not determined | 77.3 | 0.556 |
| precipitation | due to crystal | 80.1 | 0.465 |
| | precipitation | | |

As apparent from FIG. 8, each of Examples 23 to 32 had a water activity of less than 0.60 at a solid content of 75%. In particular, Example 24 had a very low water activity of 0.493 at a solid content of 75%. The water activities of Examples 23 and 24 greatly differ from each other from comparison. This result revealed that the combination use of glucose with xylitol and erythritol can achieve a great water activity reduction effect, although the mechanism is unclear. In contrast, Comparative Example 21 having a high sorbitol content and Comparative Example 25 in which fructose was used in place of the glucose in Example 30 resulted in a water activity of more than 0.60 at a solid content of 75%. In Comparative Example 22 having a low sorbitol content and Comparative Examples 23 and 24 each having a high erythritol content, the crystal precipitated before the solid content in the aqueous solution of each water activity reducing agent reached 75%.

### Examples 33 to 40

### (1) Preparation of Water Phase Components 1 to 7

The water activity reducing agents of Examples 23, 24, and 28, sucrose, and fresh cream were used in a ratio (%) shown in Table 10. These ingredients were mixed. If desired, water was added to the mixture and/or the mixture was heated, thereby adjusting the water content to an intended value. Consequently, a water phase component of a water-containing chocolate was prepared. The water activity reducing agent used in each Example in Table 10 was a syrup-like water activity reducing agent adjusted to have a Bx of 70 and the used fresh cream had a milk fat of 46%. Table 10 shows the water activities of the obtained water phase components.

TABLE 10

| | Water phase component | | | | | | |
|---|---|---|---|---|---|---|---|
| Ingredient name | 1 | 2 | 3 | 4 | 5 | 6 | 7 |
| Example 23(Bx70) | 57.14 | 57.14 | 57.14 | 57.14 | 57.14 | 0 | 0 |
| Example 24(Bx70) | 0 | 0 | 0 | 0 | 0 | 0 | 57.14 |
| Example 28(Bx70) | 0 | 0 | 0 | 0 | 0 | 57.14 | 0 |
| Sucrose | 0 | 0 | 10 | 10 | 20 | 0 | 0 |
| Fresh cream (milk fat 46%) | 20 | 20 | 25 | 25 | 30 | 20 | 20 |
| Water content | 29.2% | 34.0% | 27.5% | 28.9% | 25.0% | 31.2% | 34.0% |
| Aw | 0.600 | 0.690 | 0.621 | 0.664 | 0.601 | 0.701 | 0.685 |

### (2) Preparation of Chocolate Dough Pieces 1 and 2

Chocolate dough pieces 1 and 2 used as an oil phase component were prepared by rolling and conching method. The chocolate dough piece 1 included 39 parts of sucrose, 24 parts of cacao butter, 24 parts of whole milk powder, 12 parts of cacao mass, and 1 part of lecithin and the chocolate dough piece 2 included 42 parts of sucrose, 12 parts of cacao butter, 45 parts of cacao mass, and 1 part of lecithin.

### (3) Preparation of Water-Containing Chocolate

The water phase components 1 to 7 and the oil phase component including the chocolate dough piece 1 and/or the chocolate dough piece 2 were emulsified in an amount (part) shown in Table 11 into an oil-in-water emulsion to yield water-containing chocolates of Examples 33 to 40. The emulsification was carried out with a whisk and whether the oil-in-water emulsion was completed or not was visually examined.

Table 11 shows the total content [X] of carbohydrates in a water activity reducing agent, the total content [A] and [B], the content [C], and the content [D] in the water activity reducing agent, the water content [Y] of a water-containing chocolate, the proportion [Z] of the total content [X] of carbohydrates in the water activity reducing agent with respect to the water content [Y], and the water activity (Aw), in each water-containing chocolate obtained by mixing and emulsifying. The oil phase components 1 and 2 in Table 11 indicate the chocolate dough pieces 1 and 2, respectively. For sensory evaluation described later, each water-containing chocolate prepared was poured into a flat mold for chocolate, then solidified, and cut into a piece having a thickness of 1 cm, a length of 2 cm, and a width of 2 cm.

TABLE 11

| | | Example | | | | | | | |
|---|---|---|---|---|---|---|---|---|---|
| | | 33 | 34 | 35 | 36 | 37 | 38 | 39 | 40 |
| Water phase | 1 | 50 | 60 | 66.7 | | | | | |
| component | 2 | | | | 50 | | | | |
| | 3 | | | | | | | | |
| | 4 | | | | | | | | |
| | 5 | | | | | 50 | 66.7 | | |
| | 6 | | | | | | | 50 | |
| | 7 | | | | | | | | 50 |
| Oil phase | 1 | 50 | 40 | 33.3 | | 50 | 33.3 | 25 | |
| component | 2 | | | | 50 | | | 25 | 50 |

| | | | | | | | | |
|---|---|---|---|---|---|---|---|---|
| [X] | 28.8% | 34.5% | 38.4% | 27.5% | 23.6% | 31.4% | 23.1% | 27.5% |
| [A] + [B] | 25.0% | 25.0% | 25.0% | 25.0% | 25.0% | 25.0% | 25.0% | 25.0% |
| [C] | 50.0% | 50.0% | 50.0% | 50.0% | 50.0% | 50.0% | 50.0% | 50.0% |
| [D] | 25.0% | 25.0% | 25.0% | 25.0% | 25.0% | 25.0% | 25.0% | 25.0% |
| [Y] | 14.6% | 17.5% | 19.5% | 16.2% | 13.8% | 18.3% | 14.5% | 16.2% |
| [Z] | 197% | 197% | 197% | 170% | 171% | 171% | 160% | 170% |
| Aw | 0.541 | 0.535 | 0.550 | 0.587 | 0.573 | 0.580 | 0.599 | 0.589 |

### (Sensory Evaluation)

The prepared water-containing chocolates of Examples 33 to 40 were subjected to sensory evaluation of flavor and texture. The sensory evaluation of each sample was carried out by ten panelists on three items of “sweetness”, “cool feeling”, and “texture.” Here, the “sweetness” means unpleasant sweetness that is especially derived from sorbitol and is remaining chilly, unfavorable sweetness, and the “cool feeling” means feeling by a phenomenon based on the endothermic reaction caused by taking especially erythritol and xylitol. The “texture” evaluation is whether a sample has no starch syrup-like viscous texture or not and has good meltability in the mouth or not.

The sensory evaluation resulted in that each of Examples 33 to 40 had no sweetness particular to the sugar alcohol and no cool feeling derived from xylitol and erythritol. The texture evaluation also revealed that each sample had no starch syrup-like texture and had good meltability in the mouth.

### Examples 41 to 46 and Comparative Examples 26 to 28

Sorbitol (A), glucose (B), xylitol (C), erythritol (D), and glycerin (E) were mixed in a ratio (%) shown in Table 12 to yield the water activity reducing agents of Examples 41 to 46 and Comparative Examples 26 to 28. In Comparative Example 28, the water activity reducing agent for reference was prepared in a similar manner to that in Example 46 except that fructose (F) was used in place of glucose (B). Next, each water activity reducing agent of Examples 41 to 46 and Comparative Examples 26 to 28 was dissolved in water in a solid content (%) shown in Table 12 and the water activity of each aqueous solution was determined. Table 12 shows the results. Table 12 shows the total content [A] and [B] and the contents [C] to [E] in each water activity reducing agent.

FIG. 9 shows the water activity of each water activity reducing agent of Examples 41 to 46 and Comparative Examples 26 to 28 at a solid content of 75%. FIG. 9 is a graph showing the water activity of each aqueous solution of the water activity reducing agents of Examples 41 to 46 and Comparative Examples 26 to 28, sorbitol (S), glycerin (G1), and xylitol (X) at a solid content of 75%. In FIG. 9, “E41” to “E46” represent Examples 41 to 46, respectively, “CE26” to “CE28” represent Comparative Examples 26 to 28, respectively, “S” represents sorbitol alone, “G1” represents glycerin alone, and “X” represents xylitol alone.

TABLE 12

| Example 41 | | Example 42 | | Example 43 | | Example 44 | | Example 45 | | Example 46 | |
|---|---|---|---|---|---|---|---|---|---|---|---|
| (A) 5% | | (A) 12.5% | | (A) 25% | | (A) 20% | | (A) 20% | | (A) 15% | |
| (B) 0% | | (B) 0% | | (B) 5% | | (B) 20% | | (B) 0% | | (B) 40% | |
| (C) 50% | | (C) 50% | | (C) 25% | | (C) 20% | | (C) 50% | | (C) 20% | |
| (D) 25% | | (D) 25% | | (D) 25% | | (D) 20% | | (D) 25% | | (D) 20% | |
| (E) 20% | | (E) 12.5% | | (E) 20% | | (E) 20% | | (E) 5% | | (E) 5% | |
| [A] + [B] 5% | | [A] + [B] 12.5% | | [A] + [B] 30% | | [A] + [B] 40% | | [A] + [B] 20% | | [A] + [B] 55% | |
| [C] 50% | | [C] 50% | | [C] 25% | | [C] 20% | | [C] 50% | | [C] 20% | |
| [D] 25% | | [D] 25% | | [D] 25% | | [D] 20% | | [D] 25% | | [D] 20% | |
| [E] 20% | | [E] 12.5% | | [E] 20% | | [E] 20% | | [E] 5% | | [E] 5% | |
| Solid content | Aw | Solid content | Aw | Solid content | Aw | Solid content | Aw | Solid content | Aw | Solid content | Aw |
| 68.0 | 0.597 | 64.1 | 0.692 | 57.5 | 0.768 | 61.8 | 0.737 | 62.7 | 0.725 | 58.4 | 0.762 |
| 72.0 | 0.513 | 71.0 | 0.572 | 60.3 | 0.731 | 68.5 | 0.641 | 65.4 | 0.699 | 62.6 | 0.729 |
| 74.8 | 0.445 | 74.6 | 0.475 | 65.4 | 0.661 | 72.5 | 0.566 | 67.7 | 0.659 | 65.8 | 0.691 |
| 76.6 | 0.395 | 83.2 | 0.258 | 71.1 | 0.548 | 77.2 | 0.461 | 71.0 | 0.599 | 69.9 | 0.640 |
| | | | | 75.6 | 0.442 | 80.0 | 0.356 | 77.2 | 0.475 | 75.5 | 0.529 |
| | | | | 79.1 | 0.334 | 82.2 | 0.252 | 80.0 | 0.417 | 80.8 | 0.419 |
| | | | | 81.0 | 0.257 | | | 81.9 | 0.358 | | |

| Comparative Example 26 | | Comparative Example 27 | | Comparative Example 28 | |
|---|---|---|---|---|---|
| (A) 20% | | (A) 20% | | (A) 15% | |
| (B) 20% | | (B) 0% | | (F) 40% | |
| (C) 15% | | (C) 55% | | (C) 20% | |
| (D) 15% | | (D) 25% | | (D) 20% | |
| (E) 30% | | (E) 0% | | (E) 5% | |
| [A] + [B] 40% | | [A] + [B] 20% | | [A] + [F] 55% | |
| [C] 15% | | [C] 55% | | [C] 20% | |
| [D] 15% | | [D] 25% | | [D] 20% | |
| [E] 30% | | [E] 0% | | [E] 5% | |
| Solid content | Aw | Solid content | Aw | Solid content | Aw |
| 62.5 | 0.725 | 57.5 | 0.795 | 56.8 | 0.818 |
| 69.0 | 0.630 | 61.9 | 0.750 | 57.9 | 0.804 |
| 70.7 | 0.600 | 73.5 | 0.633 | 64.8 | 0.736 |
| 73.2 | 0.551 | 80.0 | 0.430 | 68.1 | 0.693 |
| 75.5 | 0.502 | 82.6 | 0.289 | 75.1 | 0.570 |
| 78.5 | 0.412 | | | 77.5 | 0.513 |
| | | | | 83.2 | 0.378 |

As apparent from FIG. 9, each of Examples 41 to 46 had a lower water activity than that of glycerin at a solid content of 75%. In particular, Examples 41 to 43 had a very low water activity of less than 0.50 at a solid content of 75%. Among them, Example 41 had a remarkably low water activity of about 0.440 (the actual measured value was 0.445 at a solid content of 74.8%). In contrast, Comparative Example 26 having a high glycerin content had a very low water activity of 0.513 at a solid content of 75% but had very strong glycerin flavor, which was unfavorable as a food product. Comparative Example 27 without glycerin had a higher water activity than that of glycerin at a solid content of 75%. Comparative Example 28 in which fructose was used in place of the glucose in Example 46 had a low water activity of less than 0.60, which was a little higher than that of glycerin alone, at a solid content of 75%. This result remarkably differs from Example 46. This is supposed to be because fructose has no interaction with other carbohydrates.

### Examples 47 to 53

### Water-Containing Chocolate

### (1) Preparation of Water Phase Components 1 to 5

The water activity reducing agents of Examples 42 and 45, sucrose, and fresh cream were used in a ratio (%) shown in Table 13. These ingredients were mixed. If desired, water was added to the mixture and/or the mixture was heated, thereby adjusting the water content to an intended value. Consequently, a water phase component of a water-containing chocolate was prepared. The water activity reducing agent used in each Example in Table 13 was a syrup-like water activity reducing agent adjusted to have a Bx of 70 and the used fresh cream had a milk fat of 46%. Table 13 shows the water activities of the obtained water phase components.

TABLE 13

| | Water phase component | | | | |
|---|---|---|---|---|---|
| Ingredient name | 1 | 2 | 3 | 4 | 5 |
| Example 42(Bx70) | 57.14 | 57.14 | 57.14 | 0 | 0 |
| Example 45(Bx70) | 0 | 0 | 0 | 57.14 | 57.14 |
| Sucrose | 0 | 0 | 10 | 0 | 10 |
| Fresh cream | 20 | 20 | 25 | 25 | 30 |
| (milk fat 46%) | | | | | |
| Water content | 29.2% | 34.0% | 27.5% | 28.9% | 25.0% |
| Aw | 0.570 | 0.659 | 0.552 | 0.586 | 0.532 |

### (3) Preparation of Water-Containing Chocolate

The water phase components 1 to 5 and the oil phase component including the same chocolate dough piece 1 and/or the same chocolate dough piece 2 as those prepared in Examples 33 to 40 were mixed and emulsified in an amount (part) shown in Table 14 into an oil-in-water emulsion to yield water-containing chocolates of Examples 47 to 53. The emulsification was carried out with a whisk and whether the oil-in-water emulsion was completed or not was visually examined.

The oil phase components 1 and 2 in Table 14 indicate the chocolate dough pieces 1 and 2, respectively. For sensory evaluation described later, each water-containing chocolate prepared was poured into a flat mold for chocolate, then solidified, and cut into a piece having a thickness of 1 cm, a length of 2 cm, and a width of 2 cm.

Table 14 shows the total content [X] of carbohydrates in a water activity reducing agent, the total content [A] and [B] and the contents [C] to [E] in the water activity reducing agent, the water content [Y] of a water-containing chocolate, the proportion [Z] of the total content [X] of carbohydrates in the water activity reducing agent with respect to the water content [Y], and the water activity (Aw), in each water-containing chocolate obtained.

TABLE 14

| | | Example | | | | | | |
|---|---|---|---|---|---|---|---|---|
| | | 47 | 48 | 49 | 50 | 51 | 52 | 53 |
| Water phase | 1 | 50 | 60 | 66.7 | | | | |
| component | 2 | | | | 50 | | | |
| | 3 | | | | | 50 | | |
| | 4 | | | | | | 50 | |
| | 5 | | | | | | | 50 |
| Oil phase | 1 | 50 | 40 | 33.3 | | 50 | 25 | 25 |
| component | 2 | | | | 50 | | 25 | 25 |

| | | | | | | | |
|---|---|---|---|---|---|---|---|
| [X] | 28.8% | 34.5% | 38.4% | 27.5% | 23.6% | 28.9% | 24.4% |
| [A] + [B] | 12.5% | 12.5% | 12.5% | 12.5% | 12.5% | 20.0% | 20.0% |
| [C] | 50.0% | 50.0% | 50.0% | 50.0% | 50.0% | 50.0% | 50.0% |
| [D] | 25.0% | 25.0% | 25.0% | 25.0% | 25.0% | 25.0% | 25.0% |
| [E] | 12.5% | 12.5% | 12.5% | 12.5% | 12.5% | 5.0% | 5.0% |
| [Y] | 14.6% | 17.5% | 19.5% | 16.2% | 13.8% | 14.5% | 12.5% |
| [Z] | 197% | 197% | 197% | 170% | 171% | 200% | 195% |
| Aw | 0.531 | 0.542 | 0.545 | 0.577 | 0.564 | 0.590 | 0.575 |

### (Sensory Evaluation)

The prepared water-containing chocolates of Examples 47 to 53 were subjected to sensory evaluation of flavor and texture. The sensory evaluation of each sample was carried out by ten panelists on four items of “sweetness”, “flavor”, “cool feeling”, and “texture.” Here, the “sweetness” means unpleasant sweetness that is especially derived from sorbitol and is remaining chilly, unfavorable sweetness, the “flavor” means unpleasant flavor derived from glycerin, and the “cool feeling” means feeling by a phenomenon based on the endothermic reaction caused by taking especially erythritol and xylitol. The “texture” evaluation is whether a sample has no starch syrup-like viscous texture or not and has good meltability in the mouth or not.

The sensory evaluation resulted in that each of Examples 47 to 53 had no sweetness and flavor particular to the sugar alcohols and no cool feeling derived from xylitol and erythritol and each water-containing chocolate had a rich chocolate flavor having characteristics of cacao. The texture evaluation also revealed that each sample had no starch syrup-like texture and had good meltability in the mouth.

What is claimed is:

1. A water activity reducing agent comprising two or more carbohydrates selected from the group consisting of sorbitol (A), glucose (B), xylitol (C), erythritol (D), and glycerin (E),
composition of the agent and contents [A] to [E] of the respective carbohydrates satisfying a requirement [1], [2], [3], or [4];
[1] the agent including (A) and/or (B) and (C) and the content [C] being 50 to 75% by weight;
[2] the agent including (A) and/or (B) and (D) and the content [D] being 20 to 33.3% by weight;
[3] the agent including (A) and/or (B), (C), and (D), the sum of the content [A] and the content [B] being 20 to 80% by weight, and the content [D] being more than 0% by weight and 25% by weight or less; and
[4] the agent including two or more carbohydrates selected from (A) to (D) and (E), the sum of the content [A] and the content [B] being 80% by weight or less, the content [C] being 75% by weight or less, the content [D] being 33.3% by weight or less, and the content [E] being more than 0% by weight and 25% by weight or less.

2. A food product comprising the water activity reducing agent according to claim 1.

3. The food product according to claim 2 having a water content of more than 25% by weight.

4. The food product according to claim 2 having a water content of 12 to 25% by weight and a water activity of less than 0.60 and including the water activity reducing agent in an amount of 10 to 70% by weight.

5. The food product according to claim 4, wherein the water activity reducing agent includes sorbitol (A), xylitol (B), and erythritol (C).

6. A water-containing chocolate comprising:
a water phase component; and
an oil phase component mainly containing chocolate,
the water phase component including the water activity reducing agent according to claim 1 and having a water content of 12 to 20% by weight and a water activity of less than 0.60.

7. The water-containing chocolate according to claim 6, wherein the proportion of the total content of the carbohydrates included in the water activity reducing agent with respect to the water content of the water-containing chocolate is 160 to 200% by weight and the water activity is less than 0.60.

8. A method for reducing water activity, the method comprising adding a water activity reducing agent to a food product to reduce water activity of the food product,
the water activity reducing agent being the water activity reducing agent according to claim 1.

9. The method for reducing water activity according to claim 8, wherein the water activity reducing agent is added in aqueous solution form to the food product.
